(19) United States
(12) Patent Application Publication
(10) Pub. No.: US 2014/0349099 A1
(43) Pub. Date: Nov. 27, 2014

(54) MOLDED RARE-EARTHRARE-EARTH MAGNET AND LOW TEMPERATURE SOLIDIFICATION MOLDING METHOD

(71) Applicant: NISSAN MOTOR CO., LTD., Yokohama-shi, Kanagawa (JP)

(72) Inventors: Yoshio Kawashita, Kamakura-shi (JP); Kazuhiko Takashima, Yokohama-shi (JP); Yoshitaka Uehara, Yokohama-shi (JP); Toshikazu Nanbu, Machida-shi (JP); Kiyohiro Uramoto, Yokohama-shi (JP)

(73) Assignee: Nissan Motor Co., Ltd., Yokohama-shi, Kanagawa (JP)

(21) Appl. No.: 14/368,427

(22) PCT Filed: Nov. 27, 2012
(86) PCT No.: PCT/JP2012/080635

§ 371 Date: Jun. 24, 2014

(30) Foreign Application Priority Data
Dec. 26, 2011 (JP) 2011-284181

(51) Int. Cl. H01F 41/02; H01F 1/33

(52) U.S. Cl. CPC H01F 41/0266; H01F 1/33
USPC 428/220; 264/121; 252/62.55

(57) ABSTRACT

A molded rare-earth magnet which simultaneously satisfies increased film thickness, high density, and improved magnetic properties (in particular, coercive force, residual magnetic flux density, and tight adhesion) has a rare-earth magnet phase that contains as a main component a nitride which contains Sm and Fe, in which the molded rare-earth magnet has a density of 80% or higher of the theoretical density of a molded magnet constituted of the rare-earth magnet phase, and has a structure in which particles of Zn and/or Mn have been dispersed in the molded magnet.

The present application claims priority to Japanese Patent Application No. 2011-284181, filed Dec. 26, 2011, incorporated herein in its entirety.

### TECHNICAL FIELD

The present invention relates to a molded rare-earth magnet and a low temperature solidification molding method.

### BACKGROUND

There are two major types of a rare-earth magnet that are currently used, that is, a sintered magnet and a bond magnet. The bond magnet is used after solidification molding of a raw magnetic material powder having excellent magnetic properties at room temperature using a resin.

The difference of a bond magnet compared to a sintered magnet is that, the raw magnetic material powder has magnetic properties in case of a bond magnet, but in case of a sintered magnet, the magnetic properties of raw magnetic material powder are insufficient so that excellent magnetic properties can be exhibited only by heating at high temperature enough to yield a liquid phase. Further, the raw magnetic material powder for a bond magnet has a problem that, when heated at high temperature, the magnetic properties are deteriorated.

As for the reason for having deteriorated magnetic properties, the properties are lost as the magnet compound is decomposed at high temperature like SmFeN. Further, like NdFeB magnet, magnetic powder having excellent magnetic properties due to refined crystal particle organization becomes to have coarse crystal particle by heating, yielding that the excellent magnetic properties are deteriorated, for example.

Thus, like a common sintered magnet, the process for performing solidification molding which is accompanied with particle boundary modification or a change in organization by heating at 1000° C. or so has a problem that a bulk molded product cannot be obtained.

In this regard, as a method of obtaining a bulk molded product having high density, there is a method of solidification molding by depositing a raw magnet material powder on a substrate. For example, in Journal of the Institute of Electrical Engineers of Japan A, Vol. 124 (2004), No. 10 pp. 887-891, a method of spraying in vacuum an aerosolized raw magnet material powder on a substrate is tested (aerosol deposition method; AD method).

According to the method described in Journal of the Institute of Electrical Engineers of Japan A, Vol. 124 (2004), No. 10 pp. 887-891, although a molded magnet with higher density is obtained compared to a bond magnet, gas flow rate is slow in principle, and thus there are problems that tight adhesion between particles is low so that a bulk molded product with sufficiently high density is not necessarily obtained.

### SUMMARY

Accordingly, an object of the present invention is to provide a molded magnet which can simultaneously satisfy the increase in density and the improvement in magnetic properties (coercive force, residual magnetic flux density, and tight adhesion, in particular), and a method for producing it.

The molded rare-earth magnet of the present invention has a rare-earth magnet phase that contains as the main component a nitride which contains Sm and Fe, in which the molded rare-earth magnet has a density of 80% or higher of the theoretical density of a molded magnet constituted of the rare-earth magnet phase, and has a structure in which particles of Zn and/or Mn are dispersed in the molded magnet.

### BRIEF DESCRIPTION OF THE DRAWINGS

FIG. 1 is a schematic diagram diagrammatically illustrating the constitution of an apparatus used for a cold spray method, which is a representative method for forming a powder film by which the film is formed by depositing particles, as used for the method for producing a molded magnet of the present invention.

FIG. 2A is a schematic diagram diagrammatically illustrating a testing device which is used for a nano-indentation method to measure elasto-plasticity ratio of energy accompanied with plastic deformation of particles.

FIG. 2B is a graph for calculating the elasto-plasticity ratio from the relation between indentation depth h and load P that are obtained by using the testing device of FIG. 2A. The area surrounded by the loading curve and de-loading curve in the drawing (hatched area with solid line) corresponds to the energy Ep consumed for the plastic deformation. Further, the area which is surrounded by the vertical line drawn from the maximum loading point in the loading curve to the horizontal axis (indentation depth h), the de-loading curve, and the horizontal axis (hatched area with broken line) corresponds to the energy Ee absorbed by the elastic deformation. Based on the above, a value of Ep/Ee×100(%) is obtained in relation to the energy accompanied with the plastic deformation of particles.

FIG. 3 is a graph illustrating the relation between the relative value of coercive force (H) and the Zn mixing amount (Vol %), and the relation between the residual magnetic flux density (B) and the Zn mixing amount (Vol %) in the molded magnet of Examples 1 to 4 and Comparative Example 2.

FIG. 4A is a schematic cross-sectional view illustrating diagrammatically the rotor structure of a surface permanent magnet synchronous motor (SMP or SPMSM).

FIG. 4B is a schematic cross-sectional view illustrating diagrammatically the rotor structure of an interior permanent magnet synchronous motor (IMP or IPMSM).

### DETAILED DESCRIPTION OF THE EMBODIMENTS

Herein below, the embodiments of the present invention are described with reference to the attached drawings. Meanwhile, for description of the drawings, the same element is given with the same symbol and overlapped descriptions are not provided. Further, the size ratio in the drawing can be exaggerated for convenience, and it may be different from the actual ratio.

### (A) Molded Magnet

### First Embodiment

The present embodiment relates to a molded rare-earth magnet having a rare-earth magnet phase that contains as a main component a nitride which contains Sm and Fe, in which it has a density of 80% or higher of the theoretical density of a molded magnet constituted of the rare-earth magnet phase, and has a structure in which particles of Zn and/or Mn are dispersed in the molded magnet. As described herein, the Zn/Mn particles indicate Zn and/or Mn particles. Further, a nitrogen compound is also referred to as a nitride. By having the constitution of the molded magnet of the first embodiment, the coercive force on a surface of the magnet particles within the molded magnet is improved due to the microparticles of Zn or Mn that are mixed inside the molded magnet, so that the molded magnet with excellent magnetic properties can be obtained. That is because, even though Zn or Mn is not contained per se as a constitutional material of a rare-earth magnet phase (magnet particles), Zn particle or Mn particle can be uniformly and finely dispersed just by mixing them at film forming, and also the coercive force of magnet can be effectively increased. As such, it is excellent from the viewpoint of obtaining a molded magnet with excellent magnetic properties (coercive force, residual magnet density, and tight adhesion=peeling strength). Further, since the net magnet content is increased, a small-sized but strong magnet can be obtained. As a result, magnet powder for a bond magnet which has been used by solidification molding using a resin in a related art can be molded by solidification at high density and the film thickness can be significantly increased while improving the magnetic properties, and thus it can contribute to downsizing and achievement of high performance of a motor. In this regard, according to the method described in Journal of the Institute of Electrical Engineers of Japan A, Vol. 124 (2004), No. 10 pp. 887-891, there is a problem that, as gas flow rate is slow, a big particle or a heavy particle cannot be sufficiently accelerated as a raw material powder to be used, and as the film forming speed is slow, a film thicker than 500 μm (measured value is 175 μm), which is believed to be acceptable for film forming, cannot be obtained. Further, being a kind of a vacuum process, the production needs to be carried out in a vacuum chamber unlike the process under atmospheric pressure. For such reasons, there are problems that equipment is expensive and the productivity is poor. In this regard, the present invention is to provide an excellent technique for solving the problems of Journal of the Institute of Electrical Engineers of Japan A, Vol. 124 (2004), No. 10 pp. 887-891 described above.

Herein below, constitution of the molded magnet and method for producing it (Second embodiment) are described in order.

### (1) Constitution of Molded Magnet

Constitution of the molded magnet of the present embodiment includes (1) a rare-earth magnet phase having, as a main component, a nitride containing Sm and Fe (also simply referred to as Sm—Fe—N), (2) Zn/Mn particles, and (3) specific non-magnetic metal particles as an optional component. It also has a structure in which voids are present among the particles constituting the molded magnet. As described herein, Zn/Mn particles indicate Zn and/or Mn particles. Further, the specific non-magnetic metal particles indicate non-magnetic metal particles which have 50% or less of elasto-plasticity ratio of energy accompanied with plastic deformation of particles. Herein below, constitutions of the above (1) to (3) are described.

### (1a) Rare-Earth Magnet Phase Having Sm—Fe—N as Main Component

The molded magnet of the present embodiment contains a rare-earth magnet phase which contains Sm—Fe—N as a main component. Accordingly, a molded magnet of high density nitride that is not obtainable by a process of a related art can be obtained (with a density of 80% or higher of the theoretical density), and thus it is excellent from the viewpoint of enabling downsizing of a system like motor.

Examples of the rare-earth magnet phase having, as a main component, Sm—Fe—N include Sm₂Fe₁₇Nₓ (in the formula, x is preferably 1 to 6, more preferably 1.1 to 5, even more preferably 1.2 to 3.8, even still more preferably 1.7 to 3.3, and particularly preferably 2.0 to 3.0), Sm₂Fe₇Nₓ, (Sm_{0.75}Zr_{0.25}(Fe_{0.7}Co_{0.3})Nₓ (in the formula, x is preferably 1 to 6), SmFe₁₁TiN, (in the formula, x is preferably 1 to 6), (Sm₈Z₃Fe₈₄)₈₅N₁₅, and Sm₇Fe₉₃Nₓ (in the formula, x is preferably 1 to 20), but not limited thereto. It is desirably to have a rare-earth magnet phase containing, as a main component, Sm₂Fe₁₄Nₓ (x=2.6 to 2.9), particularly preferably Sm₂Fe₁₄Nₓ (x=2.6 to 2.8), and among them, preferably Sm₂Fe₁₄Nₓ (x=2.8). The reason is that, when x=2.6 to 2.9, particularly 2.6 to 2.8, and among them, 2.8 in SmFeNₓ, the anisotropic magnet system and saturated magnetization reach their maximum to yield excellent magnetic properties. The Sm—Fe—N may be used either singly or in combination of two or more types to have a molded magnet. It is also possible to have a molded magnet with a multi-layer structure that is obtained by laminating rare-earth magnet phases of different kind of Sm—Fe—N. Even in such a case, the Sm—Fe—N may be used either singly or in combination of two or more types for each layer of the multi-layer structure to have a molded magnet.

### (1b) Content of Main Component (Sm—Fe—N)

The rare-earth magnet phase of the present embodiment may be preferably the one having Sm—Fe—N as a main component, and the Sm—Fe—N is 50% by mass or more, preferably 80% by mass or more, more preferably 90% by mass or more, and even more preferably 90 to 99% by mass compared to the entire rare-earth magnet phase. Meanwhile, the upper limit of the range is more preferably 99% by mass but not 100% by mass, because surface oxide or unavoidable impurities are included. In other words, in the present embodiment, it is sufficient to have 50% by mass or more, and although it is possible to use the one with 100% by mass, it is practically difficult to remove surface oxide or unavoidable impurities and a complex and sophisticated purifying (refining) technique is required, and thus it is expensive. For such reasons, it is not included in the more preferred range.

### (1c) Other Components or the Like Contained in Rare-Earth Magnet Phase Containing Sm—Fe—N as Main Component

In a rare-earth magnet phase containing Sm—Fe—N as main component, other elements can be also contained, and it is also included in the technical scope of the present invention. Examples of other element which can be contained include Ga, Nd, Zr, Ti, Cr, Co, Zn, Mn, V, Mo, W, Si, Re, Cu, Al, Ca, B, Ni, C, La, Ce, Pr, Pm, Eu, Gd, Tb, Dy, Ho, Er, Tm, Yb, Lu, Y, Th, and MM, but not limited thereto. They may be contained either singly or in combination of two or more types. Those elements are introduced mainly by substitution with a part of the phase structure of a rare-earth magnet phase having Sm—Fe—N as a main component, or by insertion into it.

Similarly, the rare-earth magnet phase containing Sm—Fe—N as a main component may also contain a rare-earth magnet phase which is different from Sm—Fe—N. As such different rare-earth magnet phase, an existing rare-earth magnet phase which is different from Sm—Fe—N can be mentioned. Examples of such different existing rare-earth magnet phase include Sm₂Fe₁₄B, Sm₂Co₁₄B, Sm₂(Fe₁₋ₓCoₓ)₁₄B (in the formula, x is preferably such that 0≦x≦0.5), Sm₁₅Fe₇₇B₅, Sm₁₅Co₇₇B₅, Sm_{11.77}Fe_{82.35}B_{5.88}, Sm_{11.77}Co_{82.35}B_{5.88}, Sm_{1.1}Fe₄B₄, Sm_{1.1}Co₄B₄, Sm₇Fe₃B₁₀, Sm₇Co₃B₁₀, (Sm₁₋ₓDyₓ)₁₅Fe₇₇B₈ (in the formula, x is preferably such that 0≦x≦0.4), (Sm₁₋ₓDyₓ)₁₅Co₇₇B₈ (in the formula, x is preferably such that 0 5×5 0.4), Sm₂Co₁₇Nₓ (in the formula, x is preferably 1 to 6), Sm₁₅(Fe₁₋ₓCoₓ)₇₇B₇Al₁, Sm₁₅(Fe_{0.80}Cu_{0.20})_{77-y}B₈Al_{y} (in the formula, y is preferably such that 0≦y≦5), (Sm_{0.95}Dy_{0.05})₁₅Fe_{77.5}B₇Al_{0.5}, (Sm_{0.95}Dy_{0.05})₁₅(Fe_{0.95}Co_{0.05})_{77.5}B_{6.5}Al_{0.5}Cu_{0.2}, Sm₄Fe₈₀B₂₀, Sm_{4.5}Fe₇₃Co₃GaB_{18.5}, Sm_{5.5}Fe₆₆Cr₅Co₅B_{18.5}, Sm₁₀Fe₇₄Co₁₀SiB₅, Sm_{3.5}Fe₇₈B_{18.5}, Sm₄Fe_{76.5}B_{18.5}, Sm₄Fe_{77.5}B_{18.5}, Sm_{4.5}Fe₇₇B_{18.5}, Sm_{3.5}DyFe₇₃Co₃GaB_{18.5}, Sm_{4.5}Fe₇₂Cr₂Co₃B_{18.5}, Sm_{4.5}Fe₇₃V₃SiB_{18.5}, Sm_{4.5}Fe₇₁Cr₃Co₃B_{18.5}, Sm_{5.5}Fe₆₆Cr₅Co₅B_{18.5}, Sm—Co alloy system such as SmCo₅, Sm₂Co₁₇, Sm₃Co₉, Sm₃Co₉, SmCo₂, SmCo₃, or Sm₂Co₇, Sm—Fe alloy system such as Sm₂Fe₁₇, SmFe₂, or SmFe₃, Ce—Co alloy system such as CeCo₅, Ce₂Co₁₇, Ce₂₄Co₁₁, CeCo₂, CeCo₃, Ce₂Co₇, or Ce₅Co₁₉, Nd—Fe alloy system such as Nd₂Fe₁₇, Ca—Cu alloy system such as CaCus, Tb—Cu alloy system such as TbCu₇, Sm—Fe—Ti alloy system such as SmFe₁₁Ti, Th—Mn alloy system such as ThMn₁₂, Th—Zn alloy system such as Th₂Zn₁₇, Th—Ni alloy system such as Th₂Ni₁₇, La₂Fe₁₄B, CeFe₁₄B, Pr₂Fe₁₄B, Gd₂Fe₁₄B, Tb₂Fe₁₄B, Dy₂Fe₁₄B, Ho₂Fe₁₄B, Er₂Fe₁₄B, Tm₂Fe₁₄B, Yb₂Fe₁₄B, Y₂Fe₁₄B, Th₂Fe₁₄B, La₂Co₁₄B, CeCo₁₄B, Pr₂Co₁₄B, Gd₂Co₁₄B, Tb₂Co₁₄B, Dy₂Coi₄B, Ho₂Co₁₄B, Er₂Co₁₄B, Tm₂Co₁₄B, Yb₂Co₁₄B, Y₂Co₁₄B, Th₂Co₁₄B, YCo₅, LaCo₅, PrCo₅, NdCo₅, GdCo₅, TbCo₅, DyCos, HoCo₅, ErCo₅, TmCo₅, MMCo₅, MM_{0.8}Sm_{0.2}Co₅, Sm_{0.6}Gd_{0.4}Co₅, YFe₁₁Ti, NdFe₁₁Ti, GdFe₁₁Ti, TbFe₁₁Ti, DyFe₁₁Ti, HoFe₁₁Ti, ErFe₁₁Ti, TmFe₁₁Ti, LuFe₁₁Ti, Pr_{0.6}Sm_{0.4}Co, Sm_{0.6}Gd_{0.4}Co₅, Ce(Cu_{0.72}Fe_{0.14}Cu_{0.14})_{5.2}, Ce(Cu_{0.73}Fe_{0.12}Cu_{0.14}Ti_{0.01})_{6.5}, (Sm_{0.7}Ce_{0.3}(Co_{0.72}Fe_{0.16}Cu_{0.12})₇, Sm(Cu_{0.69}Fe_{0.20}Cu_{0.10}Zr_{0.01})_{7.4}, and Sm(Co_{0.65}Fe_{0.21}Cu_{0.05}Zr_{0.02})_{7.67}, but not limited thereto. It may be used either singly or in combination of two or more types.

### (1d) Shape of Rare-Earth Magnet Phase

Shape of the rare-earth magnet phase containing Sm—Fe—N as a main component (main phase and crystalline phase) of the present embodiment can be any shape if it is within the range that does not inhibit the working effect of the present invention. Examples thereof include spherical shape, elliptical shape (length/width ratio (aspect ratio) of a cross-section of a center part parallel to the direction of long axis is desirably higher than 1.0 but equal to or less than 10), cylindrical shape, polygonal shape (for example, trigonal prism, tetragonal prism, pentagonal prism, hexagonal prism, . . . n polyhedral prism (in which n is an integer of 7 or more)), needle shape or rod shape (length/width ratio (aspect ratio) of a cross-section of a center part parallel to the direction of long axis is desirably higher than 1.0 but equal to or less than 10), plate shape, circular plate (disc) shape, flake shape, scale shape, and amorphous shape, but not limited thereto. In other words, particle shape is not particularly limited as long as particle speed or elasticity behavior with extremely poor tight adhesion is not shown. However, as an extremely flat shape does not allow acceleration, a shape as close to a spherical particle as possible is preferable. Meanwhile, since the rare-earth magnet phase of Sm—Fe—N (main phase and crystalline phase) has a crystal structure, it can be also prepared to have a pre-determined crystal shape in accordance with crystal growth.

### (1e) Size of Rare-Earth Magnet Phase (Average Particle Diameter)

The size of the rare-earth magnet phase of the present embodiment (average particle diameter), which contains Sm—Fe—N as a main component, is only required to be within a range that allows effective exhibition of the working effect of the present invention, and it is generally in the range of 1 to 10 μm, preferably 2 to 8 μm, and more preferably 3 to 6 μm. When the average particle diameter of the rare-earth magnet phase is within the range, a desired molded magnet having excellent magnetic properties (coercive force, residual magnetic flux density, and tight adhesion) can be provided. Meanwhile, because the rare-earth magnet phase of Sm—Fe—N (main phase and crystalline phase) has a crystal structure, it can be also prepared to have a pre-determined size of crystal particle in accordance with crystal growth. As described herein, the average particle diameter of the rare-earth magnet phase can be measured based on particle size distribution analysis (measurement) such as observation under SEM (scanning electron microscope) or observation under TEM (transmission electron microscope) (see, Examples). Meanwhile, in rare-earth magnet phase or its cross section, amorphous rare-earth magnet phase having different length/width ratio (aspect ratio) or amorphous particles, which do not have spherical or circular shape (cross-section shape), may be contained. Thus, the average particle diameter of the rare-earth magnet phase described above corresponds to an average value of absolute maximum length of the cross section shape of each rare-earth magnet phase within an image under observation, because the shape of the rare-earth magnet phase (or its cross section shape) is not uniform. As described herein, the absolute maximum length is the maximum length among the distances between any two points on a silhouette of the rare-earth magnet phase (or its cross section shape). However, other than that, it can be also obtained by obtaining an average value of crystallite diameter obtained by half maximum full width of diffraction peak of the rare-earth magnet phase by X ray diffraction or particle diameter of rare-earth magnet phase obtained from an image of transmission electron microscope. Meanwhile, other method for measuring average particle diameter can be performed similarly.

(1f) with Regard to Constitution of Molded Magnet Other than Rare-Earth Magnet Phase (Main Phase and Crystalline Phase)

With regard to the constitution other than the rare-earth magnet phase (main phase and crystalline phase) in the molded magnet of the present embodiment includes, as a component not functioning as a magnet, Zn and/or Mn particles and also specific non-magnetic metal particles as an optional component are present, in terms of volume ratio, at 15% or so in the entire phase and the remaining consists of voids that are present among adjacent rare-earth magnet phases. By having such a constitution, a bond magnet of a related art in which a resin is filled as a binder and molded by solidification would not need a resin so that it can be prepared to have lightweight. Further, as the void volume can be further reduced compared to the amount of resin used (binder volume), downsizing and increase in density can be achieved. As a result, solidification molding with high density is achieved so that downsizing and high performance of a system like motor can be achieved.

Herein, among the components (phase) not functioning as a rare-earth magnet, Zn and/or Mn particles dispersed in the molded magnet and the non-magnetic metal particles which have 50% or less of elasto-plasticity ratio of energy accompanied with plastic deformation of particles are confirmed with their effect in the present embodiment. Meanwhile, among the components (phase) not functioning as magnet, there are inevitable components other than Zn and/or Mn particles and the non-magnetic metal particles (Cu particles and Al particles), that are not confirmed with their effect in the present embodiment. Examples of those present on a border line with a main phase include a phase of rare-earth oxide (SmO₂ phase), Fe contamination with rare-earth elements, Fe-rich phase, Fe-poor phase, and other unavoidable impurities that are present on a border line between rare-earth magnet phases (main phase and crystalline phase).

Herein below, descriptions are given with regard to the Zn/Mn particles and non-magnetic metal particles.

(2a) Zn and/or Mn Particles Dispersed in Molded Magnet

In the present embodiment, Zn and/or Mn particles (Zn/Mn particles) that are dispersed in a molded magnet are included. As an element for improving magnetic properties of Sm—Fe—N, Mn and Zn are known. Mn has an effect of increasing coercive force, and when added as an alloy element (component) to a rare-earth magnet phase (main phase and crystalline phase), it exhibits an effect of improving coercive force according to substitution of Fe. Zn is used as a metal binder with low melting point, and by forming a non-magnetic Fe—Zn compound at bulking due to a reaction with Fe generated by thermal degradation of Sm—Fe—N, it suppresses a decrease in coercive force.

In the present embodiment, it was found that, by having a mixture molded product obtained by mixing Zn with a rare-earth magnet phase (main phase and crystalline phase) of Sm—Fe—N, the coercive force is not deteriorated in a temperature range in which Zn is not melted and also the coercive force is improved compared to a state of raw materials that are used.

In the present embodiment, it is also found that, by having a mixture molded product obtained by mixing Mn with a rare-earth magnet phase (main phase and crystalline phase) of Sm—Fe—N, the coercive force is improved even under a state in which Mn is not present as a substituting element like Sm(Fe,Mn)N, that is, a state in which the rare-earth magnet phase (main phase and crystalline phase) of SmFeN and Mn particles are mixed (mixture molded product).

In the present embodiment, it is found to be excellent that any one of three modes, that is, Zn particles only, Mn particles only, or a combination of Zn particles and Mn particles, can exhibit a desired working effect. Among them, the preferred mode is to use Zn particles only (see, Test examples 1 to 5 and 11). That is because, although Zn can contribute to the magnetic properties (the sufficient effect can be obtained), Mn particles alone do not have much contribution to the magnetic properties (the effect remains unchanged at certain level). For such reasons, as also shown in Example, use of Mn particles only is not performed, and a preferred embodiment includes a combined use with Cu particles, which are one preferred type of the specific non-magnetic metal particles (see, Test examples 9, 15, and 16).

### (2b) Shape of Zn/Mn Particles

Shape of the Zn/Mn particles of the present embodiment can be any shape if it is within the range that does not inhibit the working effect of the present invention. Examples thereof include spherical shape, elliptical shape (length/width ratio (aspect ratio) of a cross-section of a center part parallel to the direction of long axis is desirably higher than 1.0 but equal to or less than 10), cylindrical shape, polygonal shape (for example, trigonal prism, tetragonal prism, pentagonal prism, hexagonal prism, . . . N polyhedral prism (in which N is an integer of 7 or more)), needle shape or rod shape (length/width ratio (aspect ratio) of a cross-section of a center part parallel to the direction of long axis is desirably higher than 1.0 but equal to or less than 10), plate shape, circular plate (disc) shape, flake shape, scale shape, and amorphous shape, but not limited thereto. Preferably, particle shape is not particularly limited as long as particle speed or elasticity behavior with extremely poor tight adhesion is not shown. However, as an extremely flat shape does not allow acceleration, a shape as close to a spherical particle as possible is preferable.

### (2c) Size of Zn/Mn Particles (Average Particle Diameter)

The size of the Zn/Mn particles of the present embodiment (average particle diameter) is only required to be within a range that allows effective exhibition of the working effect of the present invention, and it is generally in the range of 1 to 10 jpm, preferably 2 to 8 μm, and more preferably 3 to 6 μm. When the average particle diameter of the Zn/Mn particles is within the range, a desired molded magnet having excellent magnetic properties (coercive force, residual magnetic flux density, and tight adhesion) can be provided. As described herein, the average particle diameter of the Zn/Mn particles can be measured based on particle size distribution analysis (measurement) such as observation under SEM (scanning electron microscope) or observation under TEM (transmission electron microscope) (see, Examples). Meanwhile, in the Zn/Mn particles or its cross section, Zn/Mn particles with amorphous shape having different length/width ratio (aspect ratio), which do not have spherical or circular shape (cross-section shape), may be contained. Thus, the average particle diameter of the Zn/Mn particles described above corresponds to an average value of absolute maximum length of the cross section shape of each Zn/Mn particle within an image under observation, because the shape (or its cross section shape) of the Zn/Mn particles is not uniform. As described herein, the absolute maximum length is the maximum length among the distances between any two points on a silhouette of the Zn/Mn particles (or its cross section shape). However, other than that, it can be also obtained by obtaining an average value of crystallite diameter obtained by half maximum full width of diffraction peak of the Zn/Mn particles by X ray diffraction or particle diameter of Zn/Mn particles obtained from an image of transmission electron microscope. Meanwhile, other method for measuring average particle diameter can be performed similarly.

(2d) Structure in which Zn/Mn Particles are Dispersed in Molded Magnet

Structure according to the present embodiment has Zn/Mn particles dispersed in a molded magnet. Specifically, the Zn/Mn particles are all present as a mixture molded product obtained by mixing with a rare-earth magnet phase of Sm—Fe—N (main phase and crystalline phase), and it has a structure in which they are suitably dispersed in a border line among the rare-earth magnet phases instead of being present within the rare-earth magnet phase (main phase and crystalline phase). In other words, the Zn/Mn particles are not present in a state like Sm(Fe,Mn)N or Sm(Fe,Zn)N in which Mn or Zn exists within the rare-earth magnet phase (main phase and crystalline phase) as a substituting element. In other words, they are present in the molded magnet with a state in which the rare-earth magnet phase of Sm—Fe—N (main phase and crystalline phase) and Zn/Mn particles are mixedly present (mixture molded product). Herein, a structure in which Zn/Mn particles are dispersed in the molded magnet can be determined by observing the organization of a cross section after cutting the molded magnet and by mapping after SEM diffraction (X ray diffraction of elements).

### (2e) Ratio of Zn/Mn Particles in Molded Magnet (Volume Ratio)

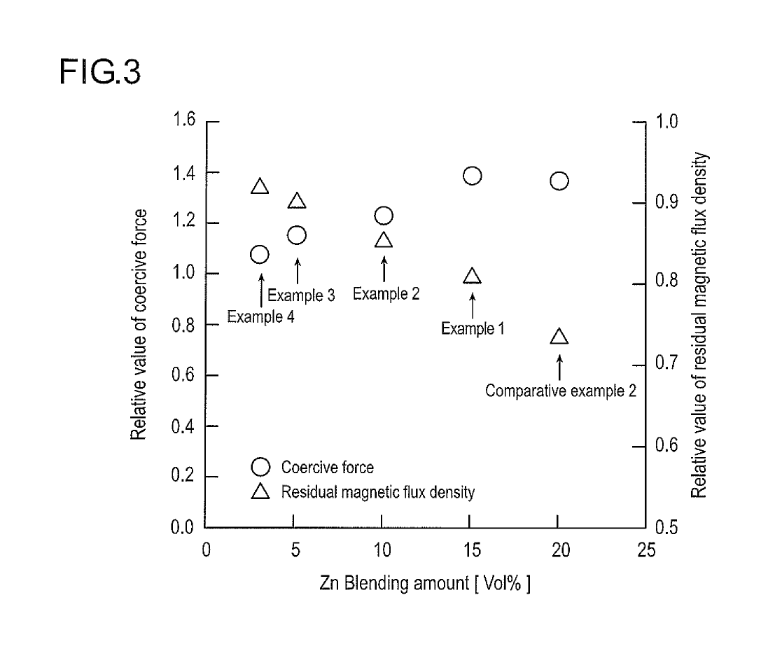

In the present embodiment, content (total amount) of the Zn/Mn particles is, in terms of volume ratio, more than 0% but equal to or less than 15%, and preferably in the range of 3 to 15%. Meanwhile, the content ratio for a case of containing Zn particles and Mn particles is not particularly limited, and any content ratio is possible (for example, see Examples 10 and 17 of Table 1). By having the content (total amount) of the Zn/Mn particles within the aforementioned range, a molded magnet having the effect of improving coercive force caused by Zn and Mn and also a small decrease in residual magnetic flux density due to insufficient net content of the rare-earth magnet phase can be obtained (see, Table 1 and FIG. 3). Even when neither Zn nor Mn is contained originally as a constitutional element of a rare-earth magnet phase consisting of magnet particles, mixing them with the volume ratio of more than 0% but equal to or less than 15% at film forming is sufficient for having uniform and fine dispersion of Zn/Mn particles within the molded magnet, and thus the coercive force of a magnet can be effectively improved. For such reasons, a molded magnet with excellent magnetic properties (coercive force, residual magnet density, tight adhesion=peeling strength) can be provided. In other words, when the content (total amount) of the Zn/Mn particles is 0%, there is a problem that sufficient magnetic properties (coercive force and residual magnetic flux density) are not obtained (Comparative Examples 4 and 5). When the content of the Zn/Mn particles is equal to or less than 15%, the effect of improving magnetic properties (in particular, residual magnetic flux density) is obtained unlike a bond magnet of a related art (compare Examples 1 to 4 with Comparative Example 2 in Table 1 and FIG. 3 for reference). Meanwhile, with regard to the volume ratio of the Zn/Mn particles, observation of the organization of a cross section was performed by SEM (scanning electron microscopy) and element mapping was performed by a method such as AES (Auger electron spectroscopy) or EPMA (electron probe micro analysis) to obtain area ratio. The area ratio was measured for any 10 viewing sections, and the average value was taken as the volume ratio.

(3a) Non-Magnetic Metal Particles which has 50% or Less of Elasto-Plasticity Ratio of Energy Accompanied with Plastic Deformation of Particles

According to the present embodiment, the molded magnet may contain non-magnetic metal particles which have 50% or less of elasto-plasticity ratio of energy accompanied with plastic deformation of particles (hereinbelow, abbreviated as non-magnetic metal particles having elasto-plasticity ratio of 50% or less). Since the easily deformable particles having elasto-plasticity ratio of 50% or less can relieve the stress accompanied with film thickening of a film, a molded magnet having high coercive force, which is unlikely to experience peeling even at film thickening, can be obtained (see, the presence or absence of peeling in Comparative Examples 4 and 5 in Table 1).

Further, by simultaneously mixing the easily deformable non-magnetic metal particles having elasto-plasticity ratio of 50% or less with the aforementioned Zn/Mn particles, a molded magnet having high coercive force, which is unlikely to experience peeling even at film thickening, can be obtained (see, Examples 6 to 10 and 12 to 17 in Table 1).

As for the easily deformable non-magnetic metal particles having elasto-plasticity ratio of 50% or less, a metal element other than Ni, Co, or Fe, which is a non-magnetic metal element, can be used as non-magnetic metal particles as long as obtainable as powder. Meanwhile, as the Zn particle and Mn particles need to be distinguished from the easily deformable non-magnetic metal particles having elasto-plasticity ratio of 50% or less, they are not included in the non-magnetic metal particles. Specifically, a soft alloy or the like such as Cu or Al used in Examples is preferably used. However, the present embodiment is not limited to them at all.

### (3b) Shape of Non-Magnetic Metal Particles Having Elasto-Plasticity Ratio of 50% or Less

Shape of the non-magnetic metal particles having elasto-plasticity ratio of 50% or less of the present embodiment can be any shape if it is within the range that does not inhibit the working effect of the present invention. Examples thereof include spherical shape, elliptical shape (length/width ratio (aspect ratio) of a cross-section of a center part parallel to the direction of long axis is desirably higher than 1.0 but equal to or less than 10), cylindrical shape, polygonal shape (for example, trigonal prism, tetragonal prism, pentagonal prism, hexagonal prism, . . . N polyhedral prism (in which N is an integer of 7 or more)), needle shape or rod shape (length/width ratio (aspect ratio) of a cross-section of a center part parallel to the direction of long axis is desirably higher than 1.0 but equal to or less than 10), plate shape, circular plate (disc) shape, flake shape, scale shape, and amorphous shape, but not limited thereto. The shape of the non-magnetic metal particles having elasto-plasticity ratio of 50% or less is not particularly limited as long as particle speed or elasticity behavior with extremely poor tight adhesion is not shown. However, as an extremely flat shape does not allow acceleration, a shape as close to a spherical particle as possible is preferable.

### (3c) Size of Non-Magnetic Metal Particles Having Elasto-Plasticity Ratio of 50% or Less (Average Particle Diameter)

The average particle diameter of the non-magnetic metal particles having elasto-plasticity ratio of 50% or less of the present embodiment is only required to be within a range that allows effective exhibition of the working effect of the present embodiment, and it is generally in the range of 1 to 10 μm, preferably 2 to 8 μm, and more preferably 3 to 6 μm. When the average particle diameter of the non-magnetic metal particles having elasto-plasticity ratio of 50% or less is within the range, a desired molded magnet having excellent magnetic properties (coercive force, residual magnetic flux density, and tight adhesion) can be provided. As described herein, the average particle diameter of the non-magnetic metal particles having elasto-plasticity ratio of 50% or less can be measured based on particle size distribution analysis (measurement) such as observation under SEM (scanning electron microscope) or observation under TEM (transmission electron microscope) (see, Examples). Meanwhile, in the non-magnetic metal particles having elasto-plasticity ratio of 50% or less or its cross section, the non-magnetic metal particles having elasto-plasticity ratio of 50% or less with amorphous shape having different length/width ratio (aspect ratio), which do not have spherical or circular shape (cross-section shape), may be contained. Thus, the average particle diameter of the non-magnetic metal particles having elasto-plasticity ratio of 50% or less described above corresponds to an average value of absolute maximum length of the cross section shape of each non-magnetic particle having elasto-plasticity ratio of 50% or less within an image under observation, because the shape (or its cross section shape) of the non-magnetic metal particles having elasto-plasticity ratio of 50% or less is not uniform. As described herein, the absolute maximum length is the maximum length among the distances between any two points on a silhouette of the non-magnetic metal particles having elasto-plasticity ratio of 50% or less (or its cross section shape). However, other than that, it can be also obtained by obtaining an average value of crystallite diameter obtained by half maximum full width of diffraction peak of the non-magnetic metal particles having elasto-plasticity ratio of 50% or less by X ray diffraction or particle diameter of non-magnetic metal particles having elasto-plasticity ratio of 50% or less obtained from an image of transmission electron microscope. Meanwhile, other method for measuring average particle diameter can be performed similarly.

(3d) Structure in which Non-Magnetic Metal Particles Having Elasto-Plasticity Ratio of 50% or Less are Dispersed in Molded Magnet

Structure according to the present embodiment has the non-magnetic metal particles having elasto-plasticity ratio of 50% or less dispersed in the molded magnet. Specifically, like the Zn/Mn particles, the non-magnetic metal particles having elasto-plasticity ratio of 50% or less are all present as a mixture molded product obtained by mixing with a rare-earth magnet phase of Sm—Fe—N (main phase and crystalline phase), and it has a structure in which they are suitably dispersed in a border line among the rare-earth magnet phases instead of being present within the rare-earth magnet phase (main phase and crystalline phase). In other words, the non-magnetic metal particles having elasto-plasticity ratio of 50% or less (e.g., Cu and Al) are not present in a state like Sm(Fe, Cu)N or SmFeNA1 in which Cu or Al exists within the rare-earth magnet phase (main phase and crystalline phase) as a substituting element. In other words, they are present in the molded magnet with a state in which the rare-earth magnet phase of SmFeN (main phase and crystalline phase) and the non-magnetic metal particles having elasto-plasticity ratio of 50% or less are mixedly present (mixture molded product). Herein, a structure in which the non-magnetic metal particles having elasto-plasticity ratio of 50% or less are dispersed in the molded magnet can be determined by observing the organization of a cross section after cutting the molded magnet and by mapping after SEM diffraction (X ray diffraction of elements).

### (3e) Ratio of Non-Magnetic Metal Particles Having Elasto-Plasticity Ratio of 50% or Less in Molded Magnet (Volume Ratio)

In the present embodiment, content (total amount) of the non-magnetic metal particles having elasto-plasticity ratio of 50% or less is, in terms of volume ratio, more than 0% but equal to or less than 20%, and preferably in the range of 1% or more but less than 20%. Smaller volume ratio would be better for not suppressing the magnetic properties (coercive force, residual magnet density, tight adhesion=peeling strength). However, the film forming property is lowered when it is zero (it is particularly significant when Zn particles or Mn particles are not contained. Compare Comparative Example 4 to Comparative Example 5 for reference). For such reasons, containing it at 1% or more but less than 20% is desirable as it allows efficient film forming. In other words, if the content (total amount) of the Zn/Mn particles is 0% and also the content of the non-magnetic metal particles is 0%, there is a problem that sufficient magnetic properties (coercive force and residual magnetic flux density) are not obtained (compare Comparative Example 4 to Comparative Example 5). However, when the content of the non-magnetic metal particles having elasto-plasticity ratio of 50% or less is less than 20%, the effect of improving magnetic properties (in particular, residual magnetic flux density) is obtained unlike a bond magnet of a related art (compare to Comparative Example 1 for reference). Meanwhile, with regard to the volume ratio of the non-magnetic metal particles having elasto-plasticity ratio of 50% or less, observation of the organization of a cross section is performed by SEM (scanning electron microscopy) and element mapping was performed by a method such as AES (Auger electron spectroscopy) or EPMA (electron probe micro analysis) to obtain area ratio. The area ratio was measured for any 10 viewing sections, and the average value was taken as the volume ratio.

### (3f) Elasto-Plasticity Ratio of Easily Deformable Non-Magnetic Metal Particles

It is sufficient that the elasto-plasticity ratio of energy accompanied with plastic deformation of the easily deformable non-magnetic metal particles is 50% or less. There is no value or critical significance of the lower limit of the elasto-plasticity ratio of easily deformable non-magnetic metal particles. However, if it is too soft, the adhesion strength becomes excessively lowered so that it is preferred to have elasto-plasticity ratio of 2.5% or so even for a soft metal. Further, as more efficient film forming can be achieved with lower elasto-plasticity ratio, the upper limit is preferably 45% or lower, and more preferably 40% or lower.

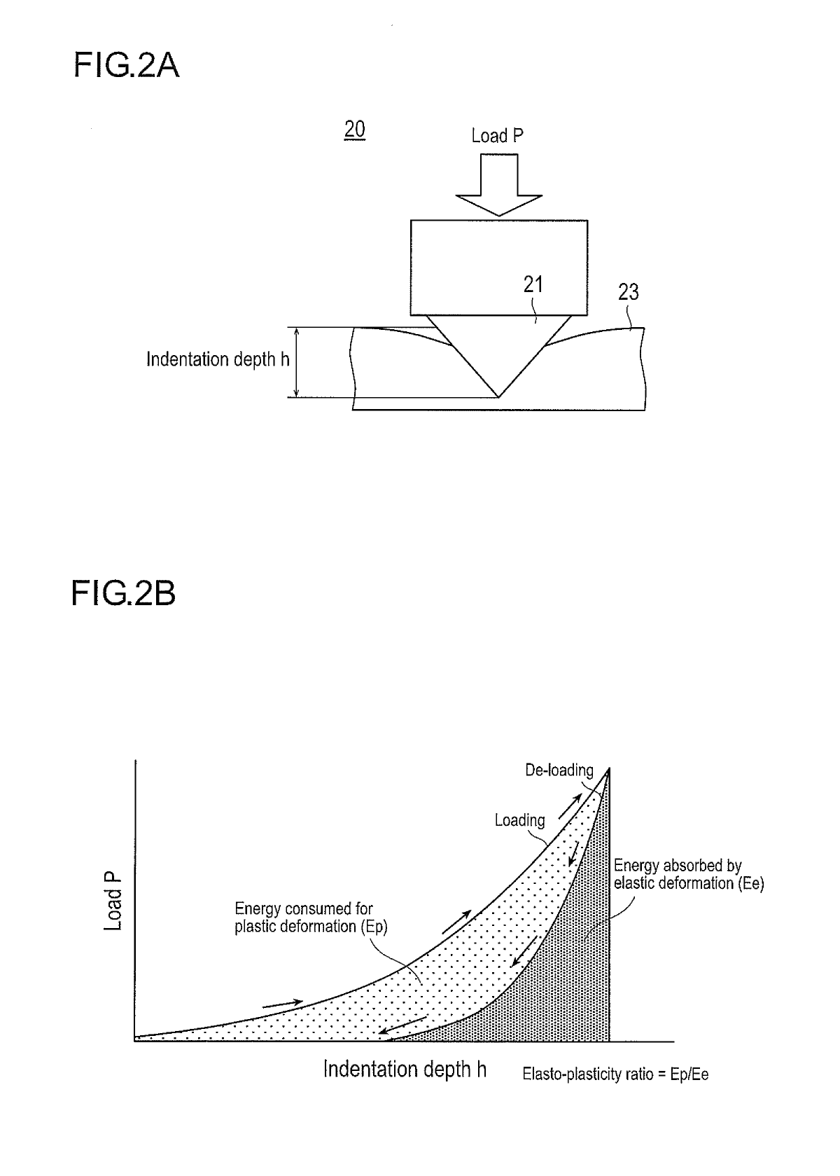

Thus, the elasto-plasticity ratio of easily deformable non-magnetic metal particles is preferably in the range of 2.5 to 50%, more preferably 2.5 to 45%, and particularly preferably 2.5 to 40%. The elasto-plasticity ratio of the energy accompanied with the plastic deformation of easily deformable non-magnetic metal particles was defined as an indicator of easy deformation based on nano-indentation method. FIG. 2A is a schematic diagram diagrammatically illustrating a testing device which is used for a nano-indentation method to obtain elasto-plasticity ratio of energy accompanied with plastic deformation of particles. FIG. 2B is a graph for calculating the elasto-plasticity ratio from the relation between indentation depth h and load P that are obtained by using the testing device of FIG. 2A. As illustrated in FIG. 2A, the nano-indentation method is a method for measuring the relation between the load (P) and displacement (indentation depth h) (indentation (load)-de-loading curve) from insertion (indentation) of the indenter 21, which is a diamond triangular pyramid, to certain load onto a surface of the sample 23 placed on a base of the testing device 20 (not illustrated) to elimination (de-loading) of the indenter 21. The indentation (load) curve illustrated in FIG. 2B reflects the elasto-plastic deformation behavior of a material and the de-loading curve is obtained based on elastic recovery behavior. Further, the area surrounded by the loading curve, de-loading curve, and horizontal line in FIG. 2B (hatched area with solid line) corresponds to the energy Ep consumed for the plastic deformation. Further, the area which is surrounded by the vertical line drawn from the maximum loading point in the loading curve to the horizontal axis (indentation depth h) and the de-loading curve (hatched area with broken line) corresponds to the energy Ee absorbed by the elastic deformation. Based on the above, a value of Ep/Ee×100(%) is obtained as elasto-plasticity ratio of an energy accompanied with the plastic deformation of particles. The Cu particles and Al particles used in Examples all have the elasto-plasticity ratio of 50% or less, for example. Specifically, the Cu particles have the elasto-plasticity ratio of 22% and the Al particles have the elasto-plasticity ratio of 38%.

(4) with Regard to Ratio (%) of Molded Magnet Compared to Theoretical Density

The molded magnet of the present embodiment has a density of 80% or higher of the theoretical density of a molded magnet constituted of the rare-earth magnet phase containing Sm—Fe—N as a main component (main phase and crystalline phase). Preferably, it has preferably 80% or more but less than 96.0%, preferably 81 to 95%, and more preferably 82 to 94.6% of the theoretical density. When the ratio compared to the theoretical density is 96.0% or more, there is a problem that the magnetic properties (in particular, coercive force, residual magnetic flux density, and tight adhesion) are not obtained at sufficient level as shown in Table 1 (see, Comparative Examples 4 and 5). Meanwhile, this is because, when the ratio compared to the theoretical density is less than 80%, the effect of improving the magnetic properties (in particular, coercive force and residual magnetic flux density) is not obtained like a bond magnet of a related art. More specifically, there is a problem that the magnetic properties (in particular, residual magnetic flux density) are not obtained at sufficient level as shown as the values of Comparative Examples 1 and 2 of Table 1 and Comparative Example 2 of FIG. 3. As described in the detailed description and the claims, the term “theoretical density” indicates the density that is obtained from a case in which the main phase of a magnet (rare-earth magnet phase) in raw material powder used is assumed to have lattice constant obtained by X ray analysis and it corresponds to 100% volume of a molded magnet. The ratio compared to theoretical density is obtained based on conversion into the ratio (%) compared to theoretical density by using that value (value of theoretical density).

### (5) Coercive Force and Residual Magnetic Flux Density of Molded Magnet

The molded magnet of the present embodiment has desirably coercive force of 1.00 or more or residual magnetic flux density of 0.75 or more, and preferably coercive force of 1.05 or more or residual magnetic flux density of 0.80 or more. That is because, even for a molded magnet obtained by using a cold spray method, a molded magnet with excellent magnetic properties (coercive force, residual magnetic flux density, and tight adhesion) satisfying the aforementioned requirements is obtained only when inert gas is used as a carrier gas. That is because, if the inert gas is not used as a carrier gas, the coercive force and residual magnetic flux density is significantly lowered, making it impossible to obtain a desired molded magnet (see, Comparative Example 3 of Table 1). Meanwhile, the coercive force and residual magnetic flux density are measured according to the method described in Examples.

### (6) Thickness of Molded Magnet

The thickness of the molded magnet of the present embodiment is not particularly limited, and it can be suitably adjusted depending on use. However, from the viewpoint of obtaining a thicker film than a bond magnet film of a related art, it is generally in the range of 200 to 3000 μm, preferably 500 to 3000 μm, and more preferably 1000 to 3000 μm in the present embodiment. In this regard, although there is no particularly significant difference in terms of film thickness compared to 175 μm (measured value) according to the AD method of a related art, there is a problem of having peeling when thickening a film more than 175 μm is tried according to the AD method of a related art. On the other hand, the present embodiment is quite excellent in that film forming can be achieved without a problem of peeling even for a thick film like 200 μm to 3000 μm. Further, when thickness of the molded magnet is 200 μm or more, a molded magnet simultaneously satisfying the film thickening, high density, and improved magnetic properties (in particular, coercive force, residual magnetic flux density, and tight adhesion) can be obtained, and therefore it can be applied to very wide range of applications. In particular, since lightweight and downsizing with high performance can be achieved, it is excellent in that it can be applied to a rare-earth magnet of all fields. When thickness of the molded magnet is 3000 μm or less, a molded magnet simultaneously satisfying the film thickening, high density, and improved magnetic properties (in particular, coercive force, residual magnetic flux density, and tight adhesion) can be obtained, and therefore it can be applied to very wide range of applications. In particular, by suitably applying to a large-size surface magnet synchronous motor or an interior magnet synchronous motor like electric parts of an automobile, lightweight and also downsizing with high performance can be achieved so that it can greatly contribute to an improvement for downsizing and lightweight of an electric car or a hybrid car.

(7) Molded Magnet Obtained by Using Powder Film Forming Process by which Film is Formed by Depositing Particles

The molded magnet of the present embodiment is obtained by using a powder film forming process by which the film is formed by depositing particles. Merit of this process is that, according to the characteristic constitution of the present invention to increase the magnetic power of the present embodiment itself (cold spray method), 80% or more of the theoretical density, which cannot be obtained by a bond magnet of a related art, can be achieved and the effect of improving the magnetic properties (in particular, coercive force, residual magnetic flux density, tight adhesion=peeling strength) is obtained. Further, even when neither Zn nor Mn is contained originally as a constitutional element of a rare-earth magnet phase (main phase and crystalline phase) consisting of magnet particles, mixing them at film forming is sufficient for having uniform and fine dispersion of Zn particles or Mn particles within the molded magnet, and thus the coercive force of a magnet can be effectively improved. For such reasons, it is excellent in that a molded magnet with excellent magnetic properties (coercive force, residual magnet flux density, tight adhesion=peeling strength) can be provided.

As described herein, the particles indicate raw material powder of a molded magnet. Specifically, as a raw material powder, those containing (1) magnet powder for constituting a rare-earth magnet phase containing Sm—Fe—N as a main component, (2) Zn/Mn particles, and (3) specific non-magnetic metal particles as an optional component can be used. As described herein, the non-magnetic metal particles indicate non-magnetic metal particles which have 50% or less of elasto-plasticity ratio of energy accompanied with plastic deformation of particles. The Zn/Mn particles indicate Zn and/or Mn particles. Further, the specific non-magnetic metal particles indicate non-magnetic metal particles which have 50% or less of elasto-plasticity ratio of energy accompanied with plastic deformation of particles. Herein below, the raw material powder components of the above (1) to (3) are described as a second embodiment.

As for the process for forming a powder film in which particles are deposited for forming film, it is desirable to use powder film forming process using a cold spray apparatus which enables obtaining a magnet simultaneously satisfying film thickening, high density, and improved magnetic properties (coercive force, residual magnetic flux density, and tight adhesion) that are the purpose of the present invention. However, it is not limited to the powder film forming process using a cold spray apparatus (cold spray method), and any powder film forming process can be used if the working effect of the present embodiment is effectively exhibited.

Herein below, the method for producing a molded magnet (second embodiment) by using a process for forming a powder film using a cold spray apparatus (cold spray method) as one representative method for producing the molded magnet of the present embodiment is described in view of the drawings.

### (B) Method for Producing Molded Magnet

### Second Embodiment

The second embodiment of the present invention relates to use of a method for producing a molded magnet using a process of forming a powder film by which the film is formed by depositing particles.

More specifically, the second embodiment is a method for producing a molded magnet including the following steps (1) and (2). Specifically, it includes a spraying step (1) in which the raw material powder containing nitride (=nitrogen compound) is mixed with carrier gas and the raw material powder is sprayed with high speed carrier gas in an accelerated state, and a solidification molding step (2) in which the sprayed raw material powder is deposited on a substrate for solidification molding. In addition to them, the present embodiment relates to a method of producing a molded magnet characterized in that the raw material powder contains nitride-based rare-earth magnet powder and Zn and/or Mn particles, temperature of the high speed carrier gas at the spraying step (1) is lower than the decomposition temperature of the nitride, and the solidification molding step (2) is performed under atmospheric pressure. The second embodiment is, in other words, a method for producing a molded magnet which uses an apparatus having a high pressure carrier gas generating unit, a heater for heating carrier gas, a raw material powder supplying unit, a carrier gas accelerating unit, and a substrate holding unit. More specifically, primary carrier gas passed through the high pressure carrier gas generating unit and the heater for heating carrier gas and raw material addition gas containing raw material powder with nitride from the raw material powder supplying unit are added to the carrier gas accelerating unit followed by mixing and acceleration, and the resulting high speed carrier gas is sprayed under atmospheric pressure. Thus, it is a method for producing a molded magnet in which the raw material powder is deposited on a substrate on the substrate holding unit by spraying of the high speed carrier gas for solidification molding. In addition to above, the present embodiment relates to a method for producing a molded magnet characterized in that the raw material powder contains nitride-based rare-earth magnet powder and Zn and/or Mn particles and solidification molding is performed while the temperature of the high speed carrier gas is lower than the decomposition temperature of the nitride. According to the present embodiment, a method for producing a magnet satisfying simultaneously the film thickening, high density, and improved magnetic properties (coercive force, residual magnetic flux density, and tight adhesion) can be provided without lowering the magnetic properties of magnet powder, and thus a desired molded magnet with suppressed deterioration in magnetic properties can be obtained (compare Examples 1 to 17 to Comparative Examples 1 to 5 for reference). Thus, the present embodiment relates to efficient production of a molded magnet which has excellent coercive force, residual magnetic flux density, and tight adhesion and also high density. One characteristic of the present embodiment is that the film forming is achieved by a cold spray method which uses a film forming apparatus referred to as a cold spray (apparatus) as an apparatus for obtaining a molded magnet by deposition of magnet powder on a substrate. Further, as a characteristic not found in the AD method of a related art which is based on a cold spray method, (1) high density can be achieved by having high particle speed, and thus magnetic properties (c density) are improved. (2) Particles with larger size can be sprayed. Thus, an occurrence of local density deviation due to non-uniformity in the molded magnet, which is caused by aggregated secondary particles (without high density) as a result of micronization of the primary particles, and also deterioration in magnetic properties can be effectively inhibited. Further, as optimization (optimum arrangement) of particles and voids can be achieved by using particles with optimum size, desired ratio (%) compared to theoretical density can be achieved. (3) Overwhelmingly high film growth speed can be achieved. As a result, a bulk product is obtained based on film thickening. Based on the properties that are not found in the AD method of a related art, the residual magnetic flux density B (%) and hardness are improved as an effect of a cold spray method by increasing density. Next, in the cold spray method, particle acceleration is achieved by heating of carrier gas instead of using a de-pressurizing device, and thus the film forming under atmospheric pressure can be achieved when a film is formed by spraying magnet powder (raw material powder) toward a substrate. However, there has been a problem that, only by application of a cold spray method to magnet powder, the magnet powder does not grow to form a film. That is because, the base is polished or the adhered film is peeled by hard magnet particles. Further, even though film thickening is required, when there is growth to thickness of several hundred μm or so, a problem of having local peeling occurs in a molded magnet. Inventors of the present invention found that those problems can be solved by mixing a small amount of soft metal particles. Further, although the temperature is significantly lower than the sintering method and very short time like several msec is required for the method of the present embodiment (cold spray method), heating to several hundred degrees (° C.) is inevitably required for particle acceleration. Further, the base temperature can be also 100° C. or higher due to collision energy, and thus the magnetic properties may be slightly deteriorated when magnetic particles having low thermal decomposition temperature like SmFeN-based rare-earth magnet are used. It was found that all of those problems can be solved by mixing Cu/Mn particles with a group of SmFeN-based magnet particles and a small amount of soft metal particles and subjecting them to a cold spray method. Meanwhile, the magnet particles with low thermal decomposition temperature may be those with 400 to 550° C. or so, although it may vary depending on components. Semi-stable nitrogen compound with instability may have decomposition temperature of 200° C. or so. Further, with regard to the slight deterioration of the magnetic properties yielded by using magnet particles with low thermal decomposition temperature, all of the magnetic properties are deteriorated, and general magnetic properties like coercive force, residual magnetization, energy product, and rectangularity are deteriorated. In the present embodiment, all of those problems can be solved by mixing Zn/Mn particles, and if necessary, non-magnetic metal particles having elasto-plasticity ratio of 50% or less, in a group of SmFeN-based magnet particles and a small amount of soft metal particles, and subjecting them to a cold spray method (compare Examples 1 to 17 to Comparative Examples 1 to 5 for reference).

### (1) Cold Spray Apparatus

Cold spray apparatus is an apparatus for forming a film by colliding at high speed, with carrier gas, a raw material powder in solid state to a substrate while the raw material powder is neither melted nor gasified.

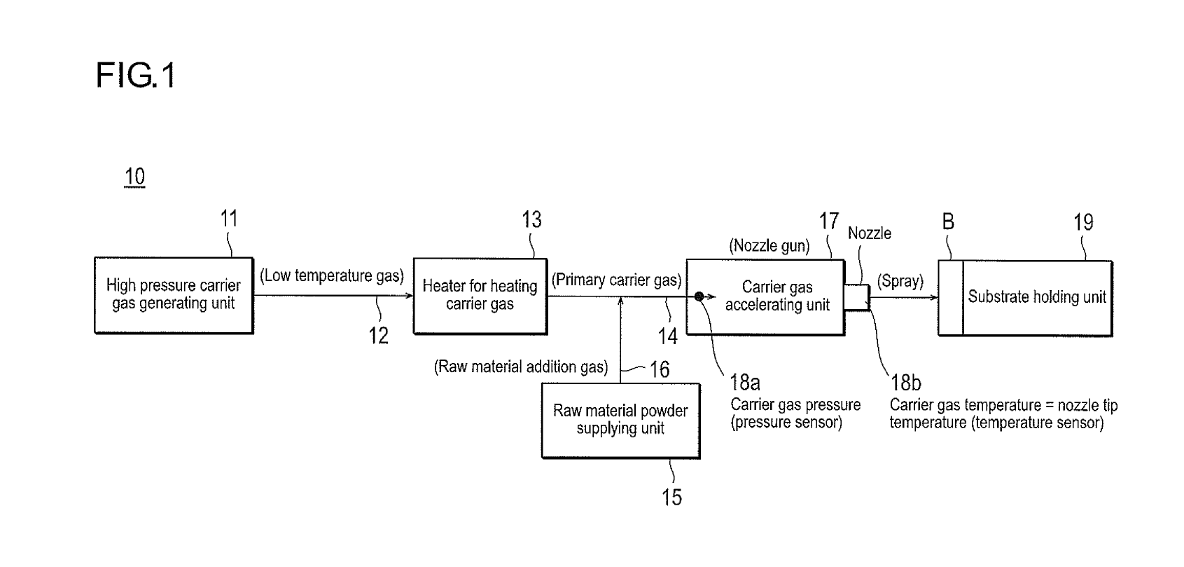

FIG. 1 is a schematic diagram diagrammatically illustrating the constitution of a cold spray apparatus used for a cold spray method, which is a representative method for forming a powder film by which the film is formed by depositing particles, as used for the method for producing a molded magnet of the present invention.

As illustrated in FIG. 1, basic constitution of the cold spray apparatus 10 of the present embodiment includes the high pressure carrier gas generating unit 11, the heater for heating carrier gas 13, the raw material powder supplying unit 15, the carrier gas accelerating unit 17, and the substrate holding unit 19. Further, between the high pressure carrier gas generating unit 11 and the heater for heating carrier gas 13, the pipe 12 is installed for pressure transport of (high pressure) carrier gas (=low temperature gas) at low temperature (between room temperature and temperature in non-heated state). Further, between the heater for heating carrier gas 13 and the carrier gas accelerating unit 17, the pipe 14 is installed for pressure transport of high temperature carrier gas (=primary carrier gas) which has been heated by the heater for heating carrier gas 13. Further, for adding raw material powder from the raw material powder supplying unit 15 to the carrier gas accelerating unit 17, the pipe 16 for injecting raw material addition gas from the raw material powder supplying unit 15 to the carrier gas accelerating unit 17 is installed. Further, the space (distance) between tip of the carrier gas accelerating unit 17 (e.g., of movable nozzle) and the surface of the substrate B installed on the substrate holding unit 19 is positioned (arranged) such that it has a constant interval. Further, the space between the carrier gas accelerating unit 17 and the substrate holding unit 19 is under atmospheric pressure (air atmosphere). With such a constitution of apparatus, it can have a constitution (structure) in which, upon the operation of the apparatus 10, raw material powder is sprayed (at ultrahigh speed) from the carrier gas accelerating unit 17 to a substrate surface on the substrate holding unit 19, with an aid of (high temperature and high pressure) high speed carrier gas accelerated in the carrier gas accelerating unit 17. Herein below, each constitutional member of the apparatus is described.

### (1a) High Pressure Carrier Gas Generating Unit

Herein, the high pressure carrier gas generating unit 11 is not particularly limited, and examples thereof include high pressure gas bombe or high pressure gas tank in which carrier gas is sealed, high pressure liquefied bombe, high pressure liquefied tank, or gas compressor in which carrier gas liquefied under high pressure is sealed, but not limited thereto. Meanwhile, the high pressure carrier gas transported under pressure from the high pressure carrier gas generating unit 11 is generally at low temperature (generally room temperature). However, liquefied gas at temperature lower than room temperature or gas heated by a heater to have temperature higher than room temperature can be also suitably used.

### (1b) Heater for Heating Carrier Gas

The heater for heating carrier gas 13 is not particularly limited, and it may have a constitution (structure) in which internal pipe for passing carrier gas is prepared in coil form so that current is allowed to flow around the coil region and the internal pipe is used as a heater for heating to heat the carrier gas within the pipe. Alternatively, it also may have a constitution (structure) in which a heater is attached to a periphery of the internal pipe for passing carrier gas, or the heater coil is wound to form a heater for heating and the carrier gas within the pipe is heated. Alternatively, it also may have a constitution (structure) in which a heater is attached to an inner surface of the internal pipe for passing carrier gas, or the heater coil is wound to form a heater for heating and the carrier gas within the pipe is heated. It is also possible to have a constitution (structure) in which carrier gas within a pipe is heated by using an infrared heater or an electronic induction coil, and thus it is not particularly limited. However, in the present embodiment, it is sufficient to have any constitution that can be effectively used as a means for heating gas, and it can be suitably selected from known means for heating gas of a related art. Further, as for the internal pipe inside the heater for heating carrier gas 13, a pipe made of steel such as carbon steel or stainless steel (SUS), high strength Ni alloy, high strength Fe alloy, Ti alloy, or so-called super strength metallic material, which have not only pressure resistance, corrosion resistance, and weather resistance but also heat resistance allowing endurance to high temperature of 400° C. or so (see, Table 1) can be used. However, the present embodiment is not limited to them, and any one effectively usable as the pipe is sufficient, and it can be suitably selected from known groups of a pipe of a related art.

### (1c) Pipe for Connecting High Pressure Carrier Gas Generating Unit to Heater for Heating Carrier Gas

As for the connecting pipe 12 which is usable for the present embodiment, those having pressure resistance, corrosion resistance, weather resistance, or the like so that it is not broken or corroded by high pressure gas that is transported under pressure from the high pressure carrier gas generating unit 11 are sufficient. Thus, it is possible to use a pipe made of steel such as carbon steel or stainless steel (SUS), a metallic material such as copper alloy, Ni alloy, Fe alloy, Ti alloy, or Al alloy, engineering plastics such as acrylic resin, polyamide resin, or polyimide resin, carbon fiber material, or a pressure resistant resin material such as Teflon (registered trade mark of a fluororesin by DuPont, USA). However, the present embodiment is not limited to them, and any one effectively usable as a pipe is sufficient, and it can be suitably selected from known groups of a pipe of a related art. Meanwhile, when the pipe 12 is also used as an internal pipe of the heater for heating carrier gas 13, it is desirable to use a pipe made of steel such as carbon steel or stainless steel (SUS), a metallic material such as copper alloy, Ni alloy, Fe alloy, Ti alloy, or Al alloy, which have not only pressure resistance, corrosion resistance, and weather resistance but also heat resistance allowing endurance to high temperature of 400° C. or so (see, Table 1).

### (1d) Pipe for Connecting Heater for Heating Carrier Gas to Carrier Gas Accelerating Unit

As for the connecting pipe 14 which is usable for the present embodiment, those having heat resistance, pressure resistance, corrosion resistance, weather resistance, or the like so that it is not melted, softened, broken, or corroded by high temperature and high pressure gas transported under pressure from the heater for heating carrier gas 13 are sufficient. Thus, it is possible to use a pipe made of steel such as carbon steel or stainless steel (SUS), a metallic material such as copper alloy, Ni alloy, Fe alloy, Ti alloy, or Al alloy, and so-called super strength metallic material. Meanwhile, with regard to the heat resistance, it is desirable to have heat resistance allowing endurance to high temperature of less than 780° C. (see, Comparative Example 4 of Table 2). With regard to the pressure resistance, it is desirable to have pressure resistance allowing endurance to gas pressure of more than 0.5 MPa but equal to or less than 5 MPa. By having an integrated nozzle structure, it is also possible for the heater for heating carrier gas 13 and the carrier gas accelerating unit 17 to have a structure which does not necessarily requires installation of connecting pipe.

### (1e) Raw Material Powder Supplying Unit

In the raw material powder supplying unit 15, part of the carrier gas from the high pressure carrier gas generating unit 11 is transported under pressure via a pipe (not illustrated) to form raw material addition gas in which the raw material powder and carrier gas are adjusted to have a pre-determined mixing ratio. Alternatively, in the raw material powder supply part 15, it is also possible that the carrier gas is transported under pressure via a pipe (not illustrated) from a high pressure carrier gas generating unit (not illustrated) that is different from the high pressure carrier gas generating unit 11. Also in such a case, raw material addition gas in which the raw material powder and carrier gas are adjusted to have a pre-determined mixing ratio is formed. Meanwhile, in the present embodiment, the method for adjusting the raw material addition gas obtained by mixing the raw material powder and carrier gas is not particularly limited, and it is needless to say that it can be suitably selected from other known adjusting methods of a related art, and used. Further, the pipe 14 can be connected to the pipe 16 so that the raw material addition gas from the raw material powder supplying unit 15 is mixed with carrier gas within the pipe 14.

### (1f) Pipe for Connecting Raw Material Powder Supplying Unit to Carrier Gas Accelerating Unit

As for the connecting pipe 16 which is usable for the present embodiment, those having pressure resistance, corrosion resistance, weather resistance, or the like so that it is not broken or corroded by high pressure carrier gas transported under pressure from the high pressure carrier gas generating unit 11 or a separate high pressure carrier gas generating unit (not illustrated) are sufficient. Thus, it is possible to use a pipe made of steel such as carbon steel or stainless steel (SUS), a metallic material such as copper alloy, Ni alloy, Fe alloy, Ti alloy, or Al alloy, engineering plastics such as acrylic resin, polyamide resin, or polyimide resin, or a pressure resistant resin material such as carbon fiber material. However, the present embodiment is not limited to them, and any one effectively usable as a pipe is sufficient, and it can be suitably selected from known groups of a pipe of a related art. Meanwhile, when the pipe 16 is introduced further into the inside of the carrier gas accelerating unit 15 and used for spraying after preparing the raw material powder to have ultrahigh speed with high temperature and high pressure carrier gas, in addition to the pressure resistance, corrosion resistance, weather resistance, or the like, it is desirable to use a pipe made of steel such as carbon steel or stainless steel (SUS), or a metallic material such as copper alloy, Ni alloy, Fe alloy, Ti alloy, or Al alloy, which can endure high temperature of less than 400° C. (see, Table 1).

### (1g) Carrier Gas Accelerating Unit

The carrier gas accelerating unit 17 which may be used in the present embodiment is not particularly limited, and any one effectively usable as a means for accelerating gas is sufficient. It can be suitably selected from the known means for accelerating gas of a related art. Specifically, since an aspirator type nozzle gun or the like is used in the carrier gas accelerating unit 17, when the carrier gas is made to flow in horizontal direction, the flow rate will increase in a narrow region of the carrier gas accelerating unit 17, and thus the carrier gas can be accelerated. Further, as the flow rate increases in a narrow region of the carrier gas accelerating unit 17, the pressure is lowered due to Venturi effect. To the carrier gas with lowered pressure, the raw material addition gas is introduced from the pipe 16, and as a result, a mechanism (principle or structure) in which the inlet part of the pipe 16 has lowered pressure so that the raw material addition gas is injected under lowered pressure can be utilized. However, if there is a huge difference in gas pressure occurring between the gas of the carrier gas and the raw material addition gas, there is a possibility of having backflow of the heated primary carrier gas to the pipe 16. As such, the low temperature gas 12 is generally divided into two series so that one of them is used as the primary carrier gas and the other is used as a raw material addition gas to supply high pressure gas to the raw material powder supplying unit. When backflow of the raw material powder is constantly prevented by installing at each of the two divided series a pressure-reducing valve for pressure adjustment, the powder supply can be made. Herein below, descriptions are made for a case in which the aforementioned nozzle gun is used as the carrier gas accelerating unit 17, but it is not limited thereto, and it can be said that the same descriptions shall apply even when other means of accelerating gas described above is used.

### (1 h) Pressure Sensor 18a

As illustrated in FIG. 1, in the present embodiment, it is desirable that the pressure sensor 18a for measuring the pressure of carrier gas containing the raw material powder is installed inside the carrier gas accelerating unit 17 (e.g., inside the chamber of a nozzle gun). That is because, by having the gas pressure of more than 0.5 MPa (gas pressure of carrier gas containing raw material powder) at spraying, a method for producing a molded magnet simultaneously satisfying the film thickening, high density, and improving the magnetic properties (in particular, residual magnetic flux density) can be obtained. Examples of the adjustment include a method of controlling (adjusting) pressure or the like of the carrier gas generated from the high pressure carrier gas generating unit 11 or the raw material addition gas, but not limited thereto. Meanwhile, as for the pressure sensor 18a, those allowing accurate measurement down to 0.1 to 5.0 MPa or so as shown in Examples are desirably used. Specifically, examples of the one usable even in high temperature gas stream include XCE, HEM series, or the like manufactured by Kulite.

### (1i) Temperature Sensor 18b

As illustrated in FIG. 1, in the present embodiment, it is preferable that the temperature sensor 18b for measuring the temperature of carrier gas containing the raw material powder installed inside the carrier gas accelerating unit 17 (e.g., tip of the spray nozzle of a nozzle gun). When the temperature of the carrier gas inside the carrier gas accelerating unit 17 is set to the temperature lower than the particle growth temperature of crystal particles of rare-earth magnet powder, the raw material powder can collide and adhere (deposit) at ultrahigh speed to the substrate B together with the carrier gas, while it remains in a solid phase without being melted or gasified, to form a film (molded magnet) by solidification molding. Accordingly, a molded magnet simultaneously satisfying the film thickening, high density, and improved magnetic properties (in particular, residual magnetic flux density) can be obtained. For the adjustment, a method of controlling (adjusting) condition for heating high pressure carrier gas inside the heater for heating carrier gas 13 can be mentioned, but not limited thereto. Meanwhile, as for the temperature sensor, those allowing accurate measurement of 150 to 800° C. or so as described in Examples are desirably used. Specific examples thereof which may be used include a K type thermocouple.

### (1j) Substrate Holding Unit 19

The substrate holding unit 19 which may be used in the present embodiment is not particularly limited, if it can maintain the substrate so that raw material powder remained in a solid phase state is, together with the carrier gas, collided at ultrahigh speed to a substrate to form a film. Specific examples thereof include those having excellent pressure resistance, corrosion resistance, or weather resistance so that the substrate is strongly fixed without breaking even when the raw material powder in a solid phase state is, together with the carrier gas, collided at ultrahigh speed to a substrate to form a film. It is preferable to use a member with high heat conductivity which is suitable for effective release of heat by preventing melting or gasification as a result of high temperature caused by heating of a substrate in accordance with spraying with carrier gas or collision and deposition of raw material powder. From this point of view, a substrate holding unit using steel such as carbon steel or stainless steel (SUS), a metallic material such as copper alloy, Ni alloy, Fe alloy, Ti alloy, or Al alloy, various ceramic materials, or mineral materials (stone plate, rock plate, or the like) is desirably used. Meanwhile, in order to have effective heat release, it is also possible to have the substrate holding unit 19 equipped with a cooling means. A conventionally known cooling means, for example, forming a cooling flow path for circulating a coolant (e.g., water) inside the substrate holding unit 19, can be suitably applied.

The aforementioned cold spray apparatus 10 has a constitution (structure) in which high temperature and high pressure carrier gas at high speed as accelerated in the carrier gas accelerating unit 17 and the raw material addition gas are sprayed (at high speed) from the carrier gas accelerating unit 17 to the surface of the substrate B on the substrate holding unit 19. At that time, the raw material powder has controlled temperature according to heating of carrier gas in the heater for heating carrier gas 13 as a previous step so that it is not melted or gasified during gas-solid mixing with the high temperature and high pressure carrier gas inside the carrier gas accelerating unit 15. Accordingly, it is sprayed at ultrahigh speed, together with the high temperature and high pressure carrier gas, from the tip of the carrier gas accelerating unit 17 without melting gasifying the raw material powder, and collided and adhered (deposited) in a solid phase state to a surface of the substrate B on the substrate holding unit 19 to form a film (molded product) by solidification molding. Since the carrier gas temperature is a critical condition of the present embodiment, it is described separately.

### (1k) Distance Between Tip of Carrier Gas Accelerating Unit and Surface of Substrate B on Substrate Holding Unit

The tip of the carrier gas accelerating unit 17 (e.g., nozzle gun) and surface of substrate B placed on the substrate holding unit 19 (=distance between spray nozzle (spray pressure) and substrate) are desirably placed (arranged) with a constant interval between them. The space (distance) between the tip of the carrier gas accelerating unit 17 (e.g., nozzle gun) and surface of substrate B placed on the substrate holding unit 19 has a constant interval in the range of 5 to 30 mm, preferably 5 to 20 mm, and more preferably 5 to 15 mm. Since the space for allowing escape of the sprayed carrier gas is limited and the gas remained due to the difficulty of escape becomes a resistance, it required a certain distance for the carrier gas to have desired escape. From this point of view, it can be said that the distance between the spray nozzle (spray pressure) and the substrate needs to be 5 mm or more. In other words, when the distance between the spray nozzle (spray pressure) and the substrate is 5 mm or more, the carrier gas can easily escape, and thus there is no worry of having a resistance. It is also favorable in that the carrier gas can effectively escape to surroundings. Meanwhile, the distance between the spray nozzle (spray pressure) and the substrate of 30 mm or less is advantageous in that the raw material powder (rare-earth magnet powder) is not excessively slowed down by air resistance but it can be desirably deposited at ultrahigh speed, together with the carrier gas, according to collision and adhesion to a substrate while it remains in a solid phase state. Meanwhile, it is needless to say that the carrier gas can be efficiently recovered and used again.

### (11) Substrate B

(11-1) Material of Substrate B

Examples of a material of the substrate B include a metallic substrate such as Cu, stainless steel (SUS), Al, or carbon steel, and a ceramic substrate such as silica, magnesia, zirconia, and alumina. Cu and Al having a characteristic of allowing easy heat release and relatively low cost are desirable. Among them, from the viewpoint of having the easiest heat release, relatively stable and cheap cost, and the lower power use amount than Al during a production process (=less generation of CO₂), Cu is one of the most preferred modes.

### (11-2) Shape of Substrate B

Although the substrate B on the substrate holding unit 19 is described above that the entire surface of the substrate B has a flat surface structure like flat plate, even when the substrate B has a shape with curve like barrel (cylinder) shape and spherical shape, the molded magnet can be formed on a desired region with a shape like barrel (cylinder) shape and spherical shape by using a known coating technique. For example, a uniform coating film (multilayer coating film) is formed by using a nozzle gun (spray gun) and the substrate holding member 19 on a surface of an automobile (e.g., body) or a home appliance having non-uniform and complex curved surfaces as shown in a technique of coating an automobile or a home appliance. Also in the present embodiment, a molded magnet can be formed (coated) on a desired surface of the substrate B (including inner surface) in any shape by applying the previously established technique of coating an automobile or a home appliance.

In other words, the substrate B is not particularly limited, and it can have any shape corresponding to various applications in which a rare-earth magnet is used. Specifically, the substrate B may have any shape corresponding to various applications in a very broad range in which a rare-earth magnet is used, for example, consumer electronics field such as capstan motor of audio equipment, speaker, headphone, picking up CD, a motor for winding in a camera, actuator for focusing, a motor for driving rotary head of video equipment or like, motor for zooming, motor for focusing, capstan motor, optical pickup for DVD or Blu ray, air conditioning compressor, fan motor for outdoor unit, or a motor for electric shave; peripheral equipment for a computer and OA equipment such as voice coil motor, spindle motor, optical pickup for CD-ROM and CD-R, stepping motor, floater, actuator for printer, dot printer print head, or rotating sensor for copying machine; precision devices in the field of measurement, communications, and others such as stepping motor for watch, various meter, pager, vibration motor for cellular phone (including portable information terminals), motor for driving recorder pen, accelerator, undulator for light radiation, polarized magnet, ion source, various plasma sources in a device for manufacturing semiconductor, electronic polarization, or magnetic inspection bias; medical fields such as permanent magnetic type MRI, electrocardiography device, electroencephalography device, dental drill motor, magnet for fixing teeth, or magnetic necklace; FA fields such as AC servo motor, synchronous motor, brake, clutch, torque coupler, linear motor for return, or lead switch; and electric components and devices of an automobile such as retarder, ignition coil transformer, ABS sensor, detection sensor for rotation or position, sensor for suspension control, door lock actuator, ISCV actuator, motor for driving electric vehicle, motor for driving hybrid vehicle, motor for driving fuel cell vehicle, power steering, optical pick up for car navigation. However, the use in which the rare-earth magnet of the present embodiment is used is not limited at all to the aforementioned extremely small area of products (parts), and it is needless to say that it can be widely used for general applications in which the rare-earth magnet is currently used. It is also possible that, by using a substrate as a releasing material and selecting only a molded magnet which has been formed on a substrate and peeled (removed) from the surface of a substrate, it can be used for various applications. For such a case, it is sufficient that the shape of a substrate is prepared to have a shape applicable for the use, and examples thereof include a plate (disc) shape polygon (triangle, square, trapezoid, hexagon, circular shape or the like), a wave plate polygon (triangle, square, trapezoid, hexagon, circular shape or the like), or a donut shape, but not particularly limited.

Outline of the cold spray apparatus 10 of the present embodiment is as described above. However, the present embodiment is not limited to them, and it is sufficient to have an apparatus which allows film formation according to ultrahigh speed collision of raw material powder with carrier gas to a substrate while the raw material powder is collided in a solid phase state without being melted or gasified. A known apparatus for cold spray can be suitably used.

### (2) Cold Spray Method

Cold spray method is a method for forming a film by colliding at ultrahigh speed, with carrier gas, raw material powder in solid state to a substrate while the raw material powder is neither melted nor gasified.

The present embodiment is a method for producing a molded magnet by depositing and solidification molding of raw material powder with carrier gas according to addition of a raw material powder to high speed carrier gas by a cold spray method which uses the cold spray apparatus 10 described above. Specifically, in the cold spray apparatus 10, the raw material powder is added without being melted or gasified to high speed carrier gas so that the raw material powder remained in a solid phase state is collided and adhered, together with carrier gas, to a substrate at ultrahigh speed to form a film. It also relates to a method of solidification molding of a deposit (molded magnet) by depositing the raw material powder on a substrate as a result of repeating the operations. Further, the present embodiment is characterized in that the raw material powder contains nitride-based rare-earth magnet powder and Zn and/or Mn particles and the solidification molding is performed at the carrier gas temperature which is lower than the decomposition temperature of the nitride. It is characterized in that inert gas is preferably used as the carrier gas. It is characterized in that the raw material powder more preferably further contains non-magnetic metal particles which have 50% or less of elasto-plasticity ratio of energy accompanied with plastic deformation of particles.

### (2a) Carrier Gas

Herein, any gas can be used as carrier gas. For obtaining more favorable magnetic properties, inert gas such as rare gas (He, Ne, Ar, Kr, Xe, and Rn), and nitrogen gas (N₂) can be mentioned. However, inert gas like Ar, He, and N₂, which is easily obtainable, cheap, and not causing deterioration of the magnetic properties, is preferably used. Use of those inert gas as carrier gas is favorable in that a molded magnet with high density (bulk molded product) can be obtained without lowering magnetic properties of rare-earth magnet powder. N₂ is advantageous in that the nitride is hardly decomposed so that heat resistance can be enhanced by using N₂, and He gas is advantageous in that, as having small molecular weight, it is easy to obtain gas speed. For preventing oxidation, hydrogen may be contained, in particular. N₂—H₂ gas is advantageous in that it can be obtained at low cost as ammonia-decomposed gas. Meanwhile, when carrier gas containing active gas like air or oxygen gas is used as carrier gas, it is found that the coercive force and residual magnetic flux density as the magnetic properties are extremely deteriorated (significantly worsened), that is, to 0.31 and 0.34, respectively, as shown in Comparative Example 3. Based on that, it can be said that, in the present embodiment, it may be preferable to use inert gas as described above.

### (2b) Preparation of High Speed Carrier Gas

The high speed carrier gas used in the present embodiment is prepared in the following procedure by using the cold spray apparatus 10. First, low temperature carrier gas (also referred to as low temperature gas) is generated in the carrier gas generating unit 11. The generated low temperature gas is transported under pressure via the pipe 12 and transformed into high temperature carrier gas (also referred to as primary carrier gas) under heating by a heater, that is, the heater for heating carrier gas 13. Next, the raw material addition gas and the primary carrier gas which have been adjusted to have a pre-determined mixing ratio between the raw material powder and the primary carrier gas are mixed in the raw material powder supplying unit 15, and accelerated in the carrier gas accelerating unit 17 for preparation of high speed carrier gas. After that, the high speed carrier gas containing the raw material powder is sprayed at ultrahigh speed toward the substrate, thereby forming a molded magnet on the substrate.

### (2c) Low Temperature Gas

As described above, the low temperature gas is the carrier gas at low temperature which is generated by the carrier gas generating unit 11.

(2c-1) Temperature of Low Temperature Gas

As described herein, the temperature of the low temperature gas is not particularly limited, if it is within the range in which the working effect of the present embodiment is not inhibited. As a general standard, temperature of the low temperature gas is in the range of −30 to 80° C., preferably 0 to 60° C., and more preferably 20 to 50° C. However, it is not limited to those ranges, and as long as it is within the range in which the working effect of the present embodiment is not inhibited, it is needless to say that those outside the range are also included in the technical scope of the present embodiment. When the temperature of the low temperature gas is −30° C. or higher, preferably 0° C. or higher, and particularly preferably 20° C. or higher, there is a merit that dew condensation in a pipe can be prevented and deterioration of the properties of a material as caused by moisture incorporation can be prevented. When the temperature of the low temperature gas is 80° C. or lower, preferably 60° C. or lower, and particularly preferably 50° C. or lower, not only the deterioration of a pipe material can be prevented but also, in terms of safety, a burn can be prevented even when the pipe is touched by hands. Further, as the raw material powder is not exposed to unnecessary high temperature, a thick magnet film with stable quality can be obtained, and also a high pressure bombe or tank can be used at low cost without cooling.

(2c-2) Pressure of Low Temperature Gas

Pressure of the low temperature gas is not particularly limited, if it is within the range in which the working effect of the present embodiment is not inhibited. As a general standard, pressure of the low temperature gas is in the range of 0.3 to 10 MPa, and preferably 0.5 to 5 MPa. However, it is not limited to those ranges, and as long as it is within the range in which the working effect of the present embodiment is not inhibited, it is needless to say that those outside the range are also included in the technical scope of the present embodiment. When the pressure of the low temperature gas is 0.3 MPa or higher, and particularly preferably 0.5 MPa or higher, acceleration of powder can be made under high pressure and high temperature. When the pressure of the low temperature gas is 10 MPa or lower, and particularly preferably 5 MPa or lower, there is a merit that an investment on highly expensive facilities for having high pressure gas can be suppressed.

(2c-3) Flow Rate and Flow Amount of Low Temperature Gas

Flow rate of the raw material gas is not particularly limited, if it is within the range in which the working effect of the present embodiment is not inhibited. Flow amount of the low temperature gas is not particularly limited, either, if it is within the range in which the working effect of the present embodiment is not inhibited. Although a generalized defining cannot be made due to a variation depending on specifications of an apparatus, as a general standard for the flow amount of the low temperature gas, it is desirably in the range of 0.1 to 1.0 m³/minute.

### (2d) Primary Carrier Gas

Primary carrier gas indicates high temperature carrier gas which is obtained by transporting the low temperature gas generated in the carrier gas generating unit 11 to the pipe 12 under pressure and heating with a heater, that is, the heater for heating carrier gas 13.

(2d-1) Temperature of Primary Carrier Gas (Temperature for Heating by Heater)

The temperature for heater heating in the heater for heating carrier gas 13 (=temperature of primary carrier gas) is not particularly limited, if it is within the range in which the working effect of the present embodiment is not inhibited. Even when the heating temperature in the heater for heating carrier gas 13 is high temperature, the time for heating the raw material powder by heated high temperature carrier gas (primary carrier gas) is extremely short, during which it passes through the inside of a nozzle of the carrier gas accelerating unit 17 (nozzle gun) after mixing. As such, it does have almost no influence on the magnetic properties. The heater heating temperature depends on type of gas, and gas temperature, and thus it is difficult to define the temperature of gas only but is in the range of 200 to 1000° C., preferably 300 to 900° C., and more preferably 400 to 800° C. This is because it varies depending on type of gas, temperature of gas, and pressure of gas, and thus it is difficult to determine the temperature of gas only. However, when it is 200° C. or higher, excessive decrease in temperature can be avoided when admixed with the raw material addition gas, and also adjustment to the gas temperature required for high speed carrier gas at spraying of the raw material powder obtained by mixing with low temperature raw material addition gas can be made. Meanwhile, when it is 1000° C. or lower, there is no possibility of having a deterioration of the raw material powder due to excessively high temperature of the primary carrier gas, and as it is not necessary to use an expensive part and member having excellent heat resistance for the entire carrier gas heating heater 13, it is favorable from the viewpoint of saving production cost. Based on above, the heater heating temperature is preferably in the range of 200 to 1000° C. However, it is not limited to the range, and as long as it is within the range in which the working effect of the present embodiment is not inhibited, it is needless to say that those outside the range are also included in the technical scope of the present embodiment.

(2d-2) Pressure of Primary Carrier Gas

Pressure of the primary carrier gas is not particularly limited, if it is within the range in which the working effect of the present embodiment is not inhibited. As a general standard, pressure of the primary carrier gas is in the range of 0.3 to 10 MPa, and preferably 0.5 to 5 MPa. However, it is not limited to those ranges, and as long as it is within the range in which the working effect of the present embodiment is not inhibited, it is needless to say that those outside the range are also included in the technical scope of the present embodiment. When the pressure of the primary carrier gas is 0.3 MPa or higher, and particularly preferably 0.5 MPa or higher, acceleration to acceleration speed required for film forming can be made even with heavy metal particles. When the pressure of the primary carrier gas is 10 MPa or lower, and particularly preferably 5 MPa or lower, there is a merit that an investment on highly expensive facilities for obtaining high pressure gas can be suppressed.

(2d-3) Flow Rate of Primary Carrier Gas

Flow rate of the primary carrier gas is not particularly limited, if it is within the range in which the working effect of the present embodiment is not inhibited.

### (2e) Raw Material Powder

The raw material powder used in the present embodiment is adjusted in the raw material powder supplying unit 15 to have a pre-determined mixing ratio with the primary carrier gas, thereby yielding raw material addition gas.

As for the raw material powder used in the present embodiment, those containing (1) magnet powder for constituting a rare-earth magnet phase containing Sm—Fe—N or Sm—Fe as a main component, (2) Zn/Mn particles, and (3) specific non-magnetic metal particles as an optional component can be used. As described herein, Sm—Fe—N indicates a nitride containing Sm and Fe. Sm—Fe indicates a compound other than the nitride containing Sm and Fe. The Zn/Mn particles indicate Zn and/or Mn particles. Further, the specific non-magnetic metal particles indicate non-magnetic metal particles which have 50% or less of elasto-plasticity ratio of energy accompanied with plastic deformation of particles. Hereinbelow, the raw material powder components of the above (1) to (3) are described.

### (2f) Magnet Powder Containing Sm—Fe—N as Main Component (Rare-Earth Magnet Phase)

The magnet powder of the present embodiment contains Sm—Fe—N as a main component. Accordingly, a molded magnet of high density nitride (having a density of 80% or higher of the theoretical density), which has not been obtained by a process of a related art, can be obtained, and it is excellent in terms of enabling downsizing of a system like motor. Examples of the magnet powder having, as a main component, Sm—Fe—N include Sm₂Fe₁₇Nₓ (in the formula, x is preferably 1 to 6, more preferably 1.1 to 5, even more preferably 1.2 to 3.8, even still more preferably 1.7 to 3.3, and particularly preferably 2.0 to 3.0), Sm₂Fe₁₇N₃, (Sm_{0.75}Zr_{0.25})(Fe_{0.7}Cu_{0.3})Nₓ (in the formula, x is preferably 1 to 6), SmFe₁₁TiNₓ (in the formula, x is preferably 1 to 6), (Sm₈Zr₃Fe₈₄)₈₅N₁₅, and Sm₇Fe₉₃N (in the formula, x is preferably 1 to 20), but not limited thereto. Preferably, magnet powder capable of exhibiting high magnetic properties like Sm₂Fe₁₄N (x=2 to 3) powder is used. That is because, unlike the sintering method, particle surface cleaning effect by a liquid phase cannot be expected and thus sufficient properties are not expected even when a molded magnet is produced by the present process using magnet powder for sintered magnet which exhibits magnetic properties after undergoing a sintering process. In other words, it is desirable to use magnet powder like Sm₂Fe₁₄Nₓ (x=2 to 3) that is not applicable to a sintering process. That is because, when the temperature of the high speed carrier gas is higher than the decomposition temperature of a nitride (magnet powder) like Sm₂Fe₁₄Nₓ (x=2 to 3), the magnetic properties are deteriorated. As the magnet powder used for the present embodiment, Sm₂Fe₁₄Nₓ (x=2.6 to 2.9) is preferably used. Particularly preferably, magnet powder in which the rare-earth magnet phase is constituted with Sm₂Fe₁₄Nₓ (x=2.6 to 2.8) is used. That is because, when x=2.6 to 2.9, and particularly 2.6 to 2.8, in SmFeNₓ, the anisotropic magnet system and saturated magnetization reach their maximum to yield excellent magnetic properties (coercive force, residual magnetic flux density, tight adhesion=peeling strength).

Further, in the present embodiment, magnet powder containing Sm—Fe as a main component can be also used. That is because, as a product process, Sm—Fe can be subjected to nitridation with N₂ carrier gas to give Sm—Fe—N. Specifically, by using N₂ gas as a carrier gas and adding and mixing the raw material addition gas containing Sm—Fe as magnet powder to primary carrier gas (high temperature N₂ gas), nitridation (nitrogenation) is achieved by heating at high temperature to give Sm—Fe—N. As such, it is also possible to obtain a molded magnet having a rare-earth magnet phase which includes Sm—Fe—N as a main component by spraying the nitridated magnet powder at high speed with the high speed carrier gas for collision and adhesion on the substrate B followed by solidification molding. In the descriptions given below, the magnet powder having Sm—Fe as a main component is also included as the magnet powder having Sm—Fe—N as a main component, and they are also simply referred to as magnet powder.

(2f-1) Content of Main Component in Magnet Powder

The content of the main component (Sm—Fe—N) of the magnet powder in the present embodiment is 50% by mass or more, preferably 80% by mass or more, more preferably 90% by mass or more, and even more preferably 90 to 99% by mass compared to the entire magnet powder. Meanwhile, the upper limit of the range is more preferably 99% by mass but not 100% by mass, because surface oxide or unavoidable impurities are included. In other words, in the present embodiment, it is sufficient to have 50% by mass or more, and although it is possible to use the one with 100% by mass, it is practically difficult to remove surface oxide or unavoidable impurities and a complex and sophisticated purifying (refining) technique is required, and thus is it expensive. For such reasons, it is not included in the more preferred range.

(2f-2) Other Components or the Like that are Contained in Magnet Powder

With regard to the magnet powder, those containing other element (component) other than the main component (Sm—Fe—N) are also included in the technical scope of the present embodiment. Examples of other element which can be contained include Ga, Nd, Zr, Ti, Cr, Co, Zn, Mn, V, Mo, W, Si, Re, Cu, Al, Ca, B, Ni, C, La, Ce, Pr, Pm, Eu, Gd, Tb, Dy, Ho, Er, Tm, Yb, Lu, Y, Th, and MM, but not limited thereto. They may be contained either singly or in combination of two or more types. Those elements are introduced mainly by substitution with a part of the phase structure of a rare-earth magnet phase represented by Sm—Fe—N, or by insertion into it.

Similarly, the magnet powder may also contain magnet powder other than Sm—Fe—N. As such a different magnet powder, an existing magnet powder which is different from Sm—Fe—N can be mentioned. Examples of such different existing magnet powder include Sm₂Fe₁₄B, Sm₂Co₁₄B, Sm₂(Fe₁₋ₓCoₓ)₁₄B (in the formula, x is preferably such that 0≦x≦0.5), Sm₁₅Fe₇₇B₅, Sm₁₅Co₇₇B_{5.88}, Sm_{11.77}Fe_{82.35}B_{5.88}, Sm_{11.77}Co_{82.35}B_{5.88}, Sm_{1.1}Fe₄B₄, Sm_{1.1}Co₄B₄, Sm₇Fe₃B₁₀, Sm₇Co₃B₁₀, (Sm₁₋ₓDyₓ)₁₅Fe₇₇B₈ (in the formula, x is preferably such that 0≦x≦0.4), (Sm₁₋ₓDyₓ)₁₅Co₇₇B₈ (in the formula, x is preferably such that 0≦x≦0.4), Sm₂Co₁₇Nₓ (in the formula, x is preferably 1 to 6), Sm₁₅(Fe₁₋ₓCoₓ)₇₇B₇Al₁, Sm₁₅(Fe_{0.08}Co_{0.20})_{77-y}B₈Al_{y} (in the formula, y is preferably such that 0≦y≦5), (Sm_{0.95}Dy_{0.05})₁₅Fe_{77.5}B₇Al_{0.5}, (Sm_{0.95}Dy_{0.05})₁₅(Fe_{0.95}Co_{0.05})_{77.5}B_{6.5}Al_{0.5}Cu_{0.2}, Sm₄Fe₈₀B₂₀, Sm_{4.5}Fe₇₃Co₃GaB_{18.5}, Sm_{5.5}Fe₆₆Cr₅Co₅B_{18.5}, Sm₁₀Fe₇₄Co₁₀SiB₅, Sm_{3.5}Fe₇₈B_{18.5}, Sm₄Fe_{76.5}B_{18.5}, Sm₄Fe_{77.5}B_{18.5}, Sm_{4.5}Fe₇₁B_{18.5}, Sm_{3.5}DyFe₇₃Co₃GaB_{18.5}, Sm_{4.5}Fe₇₂Cr₂Co₃B_{18.5}, Sm_{4.5}Fe₇₃V₃SiB_{18.5}, Sm_{4.5}Fe₇₁Cr₃Co₃B_{18.5}, Sm_{5.5}Fe₆₆Cr₅Co₅B_{18.5}, Sm—Co alloy system such as SmCo₅, Sm₂Co₁₇, Sm₃Co, Sm₃Co, SmCo₂, SmCo₃, or Sm₂Co₇, Sm—Fe alloy system such as Sm₂Fe₁₇, SmFe₂, or SmFe₃, Ce—Co alloy system such as CeCo₅, Ce₂Co₁₇, Ce₂₄Co₁₁, CeCo₂, CeCo₃, Ce₂Co₇, or Ce₅Co₁₉, Nd—Fe alloy system such as Nd₂Fe₁₇, Ca—Cu alloy system such as CaCus, Th—Cu alloy system such as TbCu₇, Sm—Fe—Ti alloy system such as SmFe₁₁Ti, Th—Mn alloy system such as ThMn₁₂, Th—Zn alloy system such as Th₂Zn₁₇, Th—Ni alloy system such as Th₂Ni₁₇, La₂Fe₁₄B, CeFe₁₄B, Pr₂Fe₁₄B, Gd₂Fe₁₄B, Tb₂Fe₁₄B, Dy₂Fe₁₄B, Ho₂Fe₁₄B, Er₂Fe₁₄B, Tm₂Fe₁₄B, Yb₂Fe₁₄B, Y₂Fe₁₄B, Th₂Fe₁₄B, La₂Co₁₄B, CeCo₁₄B, Pr₂Co₁₄B, Gd₂Co₁₄B, Tb₂Co₁₄B, Dy₂CoI₄B, Ho₂Co₁₄B, Er₂Co₁₄B, Tm₂Co₁₄B, Yb₂Co₁₄B, Y₂Co₁₄B, Th₂Co₁₄B, YCo₅, LaCo₅, PrCo₅, NdCo₅, GdCo₅, TbCo₅, DyCo₅, HoCo₅, ErCo₅, TmCo₅, MMCo₅, MM_{0.8}Sm_{0.2}Co₅, Sm_{0.6}Gd_{0.4}Co₅, YFe₁₁Ti, NdFe₁₁Ti, GdFe₁₁Ti, TbFe₁₁Ti, DyFe₁₁Ti, HoFe₁₁Ti, ErFe₁₁Ti, TmFe₁₁Ti, LuFe₁₁Ti, Pr_{0.6}Sm_{0.4}Co, Sm_{0.6}Gd_{0.4}Co₅, Ce(Cu_{0.72}Fe_{0.14}Cu_{0.14})_{5.2}, Ce(Cu_{0.73}Fe_{0.12}Cu_{0.14}Ti_{0.01})_{6.5}, (Sm_{0.7}Ce_{0.3})(Co_{0.72}Fe_{0.16}Cu_{0.12})₇, Sm(Cu_{0.69}Fe_{0.20}Cu_{0.10}Zr_{0.01})_{7.4}, Sm(Cu_{0.65}Fe_{0.21}Cu_{0.05}Zr_{0.2})_{7.67}, but not limited thereto. It may be used either singly or in combination of two or more types.

(2f-3) Shape of Magnet Powder

Shape of the magnet powder of the present embodiment can be any shape if it is within the range that does not inhibit the working effect of the present invention. Examples thereof include spherical shape, elliptical shape (length/width ratio (aspect ratio) of a cross-section of a center part parallel to the direction of long axis is desirably higher than 1.0 but equal to or less than 10), cylindrical shape, polygonal shape (for example, trigonal prism, tetragonal prism, pentagonal prism, hexagonal prism, . . . n polyhedral prism (in which n is an integer of 7 or more)), needle shape or rod shape (length/width ratio (aspect ratio) of a cross-section of a center part parallel to the direction of long axis is desirably higher than 1.0 but equal to or less than 10), plate shape, circular plate (disc) shape, flake shape, scale shape, and amorphous shape, but not limited thereto. Preferably, particle shape is not particularly limited as long as particle speed or elasticity behavior with extremely poor tight adhesion is not shown. However, as an extremely flat shape does not allow acceleration, a shape as close to a spherical particle as possible is preferable. Meanwhile, since the rare-earth magnet phase containing Sm—Fe—N (main phase and crystalline phase) has a crystal structure, it can be also prepared to have a pre-determined crystal shape in accordance with crystal growth.

(2f-4) Size of Magnet Powder (Average Particle Diameter)

The average particle diameter of the magnet powder is only required to be within a range that allows effective exhibition of the working effect of the present invention, and it is generally in the range of 1 to 10 μm, preferably 2 to 8 μm, and more preferably 3 to 6 μm. When the average particle diameter of the magnet powder is within the range, the optimum particle speed can be obtained by using a cold spray method. For such reasons, a desired molded magnet having excellent magnetic properties (coercive force, residual magnetic flux density, and tight adhesion) can be provided as the film forming can be achieved more efficiently. Specifically, when the average particle diameter is 1 μm or more, particles are not excessively light so that optimum particle speed can be obtained. As a result, the substrate is not shaven due to excessively fast particle speed and a desired molded magnet can be formed according to collision and adhesion onto a substrate at optimum speed followed by deposition. Meanwhile, when the average particle diameter of the magnet powder is 10 μm or less, the particles are not excessively heavy so that optimum particle speed can be obtained without losing the speed. In other words, as bouncing due to excessively slow particle speed after collision with a substrate does not occur, a desired molded magnet can be formed according to collision and adhesion onto a substrate at optimum speed followed by deposition. The method for measuring the average powder particle diameter can be performed in the same manner as the method for measuring average particle diameter of various particles which has been described in the first embodiment.

(2f-5) with Regard to Constitution of Raw Material Powder Other than Magnet Powder

The raw material powder of the present embodiment contains, in addition to the aforementioned magnet powder, Zn/Mn particles and (3) the specific non-magnetic metal particles as an optional component. Hereinbelow, descriptions are given with regard to the Zn/Mn particles and non-magnetic metal particles.

### (2g) Zn/Mn Particles

In the present embodiment, Zn/Mn particles are contained as a raw material powder. As an element for improving magnetic properties of Sm—Fe—N, Mn and Zn are known. Mn has an effect of increasing coercive force, and when added as an alloy element (component) to a rare-earth magnet phase (main phase and crystalline phase), it exhibits an effect of improving coercive force according to substitution of Fe. Zn is used as a metal binder with low melting point, and by forming a non-magnetic Fe—Zn compound at bulking due to a reaction with Fe generated by thermal degradation of Sm—Fe—N, it suppresses a decrease in coercive force.

In the present embodiment, it was found that, by mixing Zn particles as a raw material powder with magnet powder (Sm—Fe—N) and performing solidification molding of a molded magnet (mixture molded product), the coercive force is not deteriorated in a temperature region in which Zn particles is not melted and also the coercive force is improved compared to a state of raw materials that are used.

In the present embodiment, it is also found that, by mixing Mn particles as a raw material powder with magnet powder (Sm—Fe—N) and performing solidification molding of a molded magnet, the coercive force is improved even under a state in which Mn is not present as a substituting element like Sm(Fe,Mn)N, that is, a state of having a molded magnet (mixture molded product) in which magnet powder of SmFeN (rae-earth magnet phase) and Mn particles are mixed.

In the present embodiment, it is found to be excellent that any one of three modes, that is, Zn particles only, Mn particles only, or a combination of Zn particles and Mn particle, can exhibit a desired working effect. Among them, the preferred mode is to use Zn particles only (see, Test examples 1 to 5 and 11). That is because, although Zn particle can contribute to the magnetic properties (the sufficient effect can be obtained), Mn particles alone do not have much contribution to the magnetic properties (the effect remains unchanged at certain level). For such reasons, as also shown in Example, use of Mn particles only is not performed, and a preferred embodiment includes a combined use with Cu particles, which are one preferred type of the specific non-magnetic metal particles (see, Test examples 9, 15, and 16).

(2g-1) Shape of Zn/Mn Particles

Shape of the Zn/Mn particles of the present embodiment can be any shape if it is within the range that does not inhibit the working effect of the present embodiment. Examples thereof include spherical shape, elliptical shape (length/width ratio (aspect ratio) of a cross-section of a center part parallel to the direction of long axis is desirably higher than 1.0 but equal to or less than 10), cylindrical shape, polygonal shape (for example, trigonal prism, tetragonal prism, pentagonal prism, hexagonal prism, . . . N polyhedral prism (in which N is an integer of 7 or more)), needle shape or rod shape (length/width ratio (aspect ratio) of a cross-section of a center part parallel to the direction of long axis is desirably higher than 1.0 but equal to or less than 10), plate shape, circular plate (disc) shape, flake shape, scale shape, and amorphous shape, but not limited thereto. Preferably, particle shape is not particularly limited as long as particle speed or elasticity behavior with extremely poor tight adhesion is not shown. However, as an extremely flat shape does not allow acceleration, a shape as close to a spherical particle as possible is preferable.

(2g-2) Size of Zn/Mn Particles (Average Particle Diameter)

The size of the Zn/Mn particles of the present embodiment (average particle diameter) is only required to be within a range that allows effective exhibition of the working effect of the present invention, and it is generally in the range of 1 to 10 μm, preferably 2 to 8 μm, and more preferably 3 to 6 μm. When the average particle diameter of the Zn/Mn particles is within the range, the optimum particle speed can be obtained by using a cold spray method. For such reasons, a desired molded magnet (mixture molded product) having excellent magnetic properties (coercive force, residual magnetic flux density, and tight adhesion) can be provided as the film forming can be achieved more efficiently. Specifically, when the average particle diameter of Zn/Mn particles is 1 μm or more, particles are not excessively light so that optimum particle speed can be obtained. As a result, the substrate is not shaven due to excessively fast particle speed and a desired molded magnet (mixture molded product) can be formed according to collision and adhesion onto a substrate at optimum speed followed by deposition. Meanwhile, when the average particle diameter of the magnet powder is 10 μm or less, the particles are not excessively heavy so that optimum particle speed can be obtained without losing the speed. In other words, as bouncing due to excessively slow speed after collision with a substrate does not occur, a desired molded magnet (mixture molded product) can be formed according to collision and adhesion onto a substrate at optimum speed followed by deposition. The method for measuring the average particle diameter of particles can be performed in the same manner as the method for measuring average particle diameter of various particles which has been described in the first embodiment.

(2g-3) Ratio of Zn/Mn Particles in Raw Material Powder (Volume Ratio)

In the present embodiment, content (total amount) of the Zn/Mn particles is, in terms of volume ratio, more than 0% but equal to or less than 15%, and preferably in the range of 3 to 15%. Meanwhile, the content ratio for a case of containing Zn particles and Mn particles is not particularly limited, and any content ratio is possible (for example, see Examples 10 and 17 of Table 1). By having the content (total amount) of the Zn/Mn particles within the aforementioned range in the raw material powder, a mixture molded product having the effect of improving coercive force caused by Zn and Mn and also a small decrease in residual magnetic flux density due to insufficient net content of the rare-earth magnet phase can be obtained (see, Table 1 and FIG. 3). Even when neither Zn nor Mn is contained originally as a constitutional element of a rare-earth magnet phase consisting of magnet particles, mixing them with the volume ratio of more than 0% but equal to or less than 15% at film forming is sufficient for having uniform and fine dispersion of Zn/Mn particles within the molded magnet, and thus effective improvement of the coercive force of a magnet can be achieved. For such reasons, a molded magnet with excellent magnetic properties (coercive force, residual magnet density, tight adhesion=peeling strength) can be provided. In other words, when the content (total amount) of the Zn/Mn particles is 0%, there is a problem that sufficient magnetic properties (coercive force and residual magnetic flux density) are not obtained (Comparative Examples 4 and 5). When the content (total amount) of the Zn/Mn particles is equal to or less than 15%, the effect of improving magnetic properties (in particular, residual magnetic flux density) is obtained unlike a bond magnet of a related art (compare Examples 1 to 4 with Comparative Example 2 in Table 1 and FIG. 3 for reference). Meanwhile, with regard to the volume ratio of the Zn/Mn particles, observation of the organization of a cross section is performed by SEM (scanning electron microscopy) and element mapping was performed by a method such as AES (Auger electron spectroscopy) or EPMA (electron probe micro analysis) to obtain area ratio. The area ratio was measured for any 10 viewing sections, and the average value was taken as the volume ratio.

(2h) Non-Magnetic Metal Particles which has 50% or Less of Elasto-Plasticity Ratio of Energy Accompanied with Plastic Deformation of Particles

According to the present embodiment, the raw material powder may contain non-magnetic metal particles which have 50% or less of elasto-plasticity ratio of energy accompanied with plastic deformation of particles (hereinbelow, abbreviated as non-magnetic metal particles having elasto-plasticity ratio of 50% or less). Since the easily deformable particles having elasto-plasticity ratio of 50% or less can relieve the stress accompanied with film thickening of a film, a molded magnet having high coercive force, which is unlikely to experience peeling even at film thickening, can be obtained (see, the presence or absence of peeling in Comparative Examples 4 and 5 in Table 1).

Further, by simultaneously mixing the material powder with the easily deformable non-magnetic metal particles having elasto-plasticity ratio of 50% or less and the aforementioned Zn/Mn particles, a molded magnet having high coercive force and little peeling for enabling film thickening can be obtained (see, Examples 6 to 10 and 12 to 17 in Table 1).

As for the easily deformable non-magnetic metal particles having elasto-plasticity ratio of 50% or less, a metal element other than Ni, Co, or Fe, which is a non-magnetic metal element and obtained as powder, can be used as non-magnetic metal particles. Meanwhile, as the Zn particle and Mn particles need to be distinguished from the easily deformable non-magnetic metal particles having elasto-plasticity ratio of 50% or less, they are not included in the non-magnetic metal particles. Specifically, a soft alloy or the like such as Cu or Al used in Examples is preferably used. However, the present embodiment is not limited to them at all.

(2h-1) Shape of Non-Magnetic Metal Particles Having Elasto-Plasticity Ratio of 50% or Less

Shape of the non-magnetic metal particles having elasto-plasticity ratio of 50% or less of the present embodiment can be any shape if it is within the range that does not inhibit the working effect of the present embodiment. Examples thereof include spherical shape, elliptical shape (length/width ratio (aspect ratio) of a cross-section of a center part parallel to the direction of long axis is desirably higher than 1.0 but equal to or less than 10), cylindrical shape, polygonal shape (for example, trigonal prism, tetragonal prism, pentagonal prism, hexagonal prism, . . . N polyhedral prism (in which N is an integer of 7 or more)), needle shape or rod shape (length/width ratio (aspect ratio) of a cross-section of a center part parallel to the direction of long axis is desirably higher than 1.0 but equal to or less than 10), plate shape, circular plate (disc) shape, flake shape, scale shape, and amorphous shape, but not limited thereto. In other words, shape of the non-magnetic metal particles having elasto-plasticity ratio of 50% or less is not particularly limited as long as particle speed or elasticity behavior with extremely poor tight adhesion is not shown. However, as an extremely flat shape does not allow acceleration, a shape as close to a spherical particle as possible is preferable.

(2h-2) Size of Non-Magnetic Metal Particles Having Elasto-Plasticity Ratio of 50% or Less (Average Particle Diameter)

The average particle diameter of the non-magnetic metal particles having elasto-plasticity ratio of 50% or less of the present embodiment is only required to be within a range that allows effective exhibition of the working effect of the present embodiment, and it is generally in the range of 1 to 10 μm, preferably 2 to 8 μm, and more preferably 3 to 6 μm. When the average particle diameter of the non-magnetic metal particles having elasto-plasticity ratio of 50% or less is within the range, the optimum particle speed can be obtained by using a cold spray method. For such reasons, a desired molded magnet (mixture molded product) having excellent magnetic properties (coercive force, residual magnetic flux density, and tight adhesion) can be provided as the film forming can be achieved more efficiently. Specifically, when the average particle diameter of the non-magnetic metal particle is 1 μm or more, particles are not excessively light so that optimum particle speed can be obtained. As a result, the substrate is not shaven due to excessively fast particle speed and a desired molded magnet (mixture molded product) can be formed according to collision and adhesion onto a substrate at optimum speed followed by deposition to contribute solidification molding. Meanwhile, when the average particle diameter of the magnet powder is 10 μm or less, the particles are not excessively heavy so that optimum particle speed can be obtained without losing the speed. In other words, as bouncing due to excessively slow speed after collision with a substrate does not occur, a desired molded magnet (mixture molded product) can be formed according to collision and adhesion onto a substrate at optimum speed followed by deposition to contribute solidification molding. The method for measuring the average powder particle diameter of the particles can be performed in the same manner as the method for measuring average particle diameter of various particles which has been described in the first embodiment.

(2h-3) Ratio of Non-Magnetic Metal Particles Occupied in Raw Material Powder (Volume Ratio)

In the present embodiment, content (total amount) of the non-magnetic metal particles having elasto-plasticity ratio of 50% or less in raw material powder is, in terms of volume ratio, more than 0% but equal to or less than 20%, and preferably in the range of 1% or more but less than 20% in raw material powder. Smaller volume ratio would be better for not suppressing the magnetic properties (coercive force, residual magnet density, tight adhesion=peeling strength). However, the film forming property is lowered when it is zero (it is particularly significant when Zn particles or Mn particles are not contained. Compare Comparative Example 4 to Comparative Example 5 for reference). For such reasons, containing it at 1% or more but less than 20% is preferable as it allows efficient film forming. In other words, if the content (total amount) of the Zn/Mn particles is 0% and also the content of the non-magnetic metal particles is 0%, there is a problem that sufficient magnetic properties (coercive force and residual magnetic flux density) are not obtained (compare Comparative Example 4 to Comparative Example 5 for reference). However, when the content of the non-magnetic metal particles having elasto-plasticity ratio of 50% or less in the raw material particle is less than 20%, the effect of improving magnetic properties (in particular, residual magnetic flux density) is obtained unlike a bond magnet of a related art (compare to Comparative Example 1 for reference). Meanwhile, with regard to the volume ratio of the non-magnetic metal particles having elasto-plasticity ratio of 50% or less, observation of the organization of a cross section is performed by SEM (scanning electron microscopy) and element mapping was performed by a method such as AES (Auger electron spectroscopy) or EPMA (electron probe micro analysis) to obtain area ratio. The area ratio was measured for any 10 viewing sections, and the average value was taken as the volume ratio.

(2h-4) Elasto-Plasticity Ratio of Easily Deformable Non-Magnetic Metal Particles

It is sufficient that the elasto-plasticity ratio of energy accompanied with plastic deformation of easily deformable non-magnetic metal particles is 50% or less. There is no value or critical meaning present for the lower limit of the elasto-plasticity ratio of easily deformable non-magnetic metal particles. However, if it is too soft, the adhesion strength becomes excessively lowered so that it is preferred to have elasto-plasticity ratio of 2.5% or so even for a soft metal. Further, as more efficient film forming can be achieved with lower elasto-plasticity ratio, the upper limit is preferably 45% or lower, and more preferably 40% or lower.

Thus, the elasto-plasticity ratio of easily deformable non-magnetic metal particles is preferably in the range of 2.5 to 50%, more preferably 2.5 to 45%, and particularly preferably 2.5 to 40%. The elasto-plasticity ratio of the energy accompanied with the plastic deformation of easily deformable non-magnetic metal particles was defined as an indicator of easy deformation based on nano-indentation method. FIG. 2A is a schematic diagram diagrammatically illustrating a testing device which is used for a nano-indentation method to obtain elasto-plasticity ratio of energy accompanied with plastic deformation of particles. FIG. 2B is a graph for calculating the elasto-plasticity ratio from the relation between indentation depth h and load P that are obtained by using the testing device of FIG. 2A. As illustrated in FIG. 2A, the nano-indentation method is a method for measuring the relation between the load (P) and displacement (indentation depth h) (indentation (load)-de-loading curve) from insertion (indentation) of the indenter 21, which is a diamond triangular pyramid, to certain load onto a surface of the sample 23 placed on a base of the testing device 20 (not illustrated) to elimination (de-loading) of the indenter 21. The indentation (load) curve illustrated in FIG. 2B reflects the elasto-plastic deformation behavior of a material and the de-loading curve is obtained based on elastic recovery behavior. Further, the area surrounded by the loading curve and de-loading curve in FIG. 2B (hatched area with solid line) corresponds to the energy Ep consumed for the plastic deformation. Further, the area which is surrounded by the vertical line drawn from the maximum loading point in the loading curve to the horizontal axis (indentation depth h) and the de-loading curve (hatched area with broken line) corresponds to the energy Ee absorbed by the elastic deformation. Based on the above, a value of Ep/Ee×100(%) is obtained as elasto-plasticity ratio of an energy accompanied with the plastic deformation of particles.

### (2i) Entire Size of Raw Material Powder (Average Particle Diameter)

As described above, the raw material powder consists of (1) a rare-earth magnet phase containing, as a main component, a nitride containing Sm and Fe (also simply referred to as Sm—Fe—N), (2) Zn/Mn particles, and (3) specific non-magnetic metal particles as an optional component. With regard to the average particle diameter of the raw material powder, those having average particle diameter of generally in the range of 1 to 10 jtm, preferably 2 to 8 μm, and more preferably 3 to 6 μm are preferably used. Specifically, it is not necessary to particularly limit the average particle diameter of the raw material powder if it is within the range in which the film can grow without deteriorating the economic feasibility. However, considering metal particles with specific gravity of 6 to 8g/cm³ or so, sufficient particle speed can be obtained when the diameter is within the range of 1 to 10 μm or so. Accordingly, the film can grow with economic feasibility, and therefore it is preferable. When the average particle diameter of the raw material powder is within the range, the optimum particle speed can be obtained by using a cold spray method. For such reasons, a desired molded magnet can be provided as the film forming can be achieved more efficiently. Specifically, when the average particle diameter of raw material powder is 1 μm or more, particles are not excessively light so that optimum particle speed can be obtained. As a result, not only the substrate is not shaven due to excessively fast particle speed but also a desired molded magnet can be formed according to collision and adhesion onto a substrate at optimum speed followed by deposition. In addition, without melting or gasifying the raw material powder, a thick film with high density can be formed according to collision at ultrahigh speed=optimum particle speed to the substrate B together with the carrier gas while it remains in a solid phase state. Further, since the collision to the substrate B is made at optimum solid temperature and binding (adhesion) on the substrate B and deposition thereon can be made while the particles maintain a suitable space without integration (melting fusion), it is favorable in that a deposit (=molded magnet) with higher density and excellent magnetic properties can be obtained by solidification molding. Meanwhile, when the average particle diameter is 10 μm or less, the particles are not excessively heavy so that optimum particle speed can be obtained without losing the speed. In other words, as bouncing due to excessively slow speed after collision with a substrate does not occur, a desired molded magnet can be formed according to collision and adhesion onto a substrate at optimum speed followed by deposition. In particular, as the raw material powder does not lose its speed by air resistance under atmospheric pressure, it is possible to form a thick film with high density by colliding to the substrate B at optimum particle speed while the powder remains in a solid phase state. It is also favorable in that the raw material powder is not melted or gasified, no breaking occurs even after collision on the substrate B at optimum solid temperature, the binding (adhering) property to the substrate B is excellent, and a deposit (=molded magnet) with higher density and excellent magnetic properties can be obtained by solidification molding. The method for measuring the average powder particle diameter can be performed in the same manner as the method for measuring average particle diameter of various particles which has been described in the first embodiment.

### (2j) Raw Material Addition Gas

The raw material addition gas used in the present embodiment is obtained by adjustment in the raw material powder supplying unit 15 to have a pre-determined mixing ratio between the raw material powder and the carrier gas for preparing the raw material addition gas. Herein, the raw material powder is the same as those described above. Further, as for the carrier gas for preparing the raw material addition gas, the same gas as the aforementioned carrier gas of (2a) can be used. Meanwhile, as for the carrier gas of (2a) and the carrier gas for preparing the raw material addition gas, it is possible to use the same kind or a different kind. From the viewpoint of preventing a deviation in particle speed due to a difference in their weight, it is preferable to use the same kind.

(2j-1) Temperature of Raw Material Addition Gas

As described herein, the temperature of the raw material addition gas is not particularly limited, if it is within the range in which the working effect of the present embodiment is not inhibited. As a general standard, temperature of the raw material addition gas is in the range of −30 to 80° C., preferably 0 to 60° C., and more preferably 20 to 40° C. However, it is not limited to those ranges, and as long as it is within the range in which the working effect of the present embodiment is not inhibited, it is needless to say that those outside the range are also included in the technical scope of the present embodiment. When the temperature of the raw material addition gas is −30° C. or higher, preferably 0° C. or higher, and particularly preferably 20° C. or higher, there is a merit that dew condensation in a pipe can be prevented and deterioration of the properties of a material as caused by moisture incorporation can be prevented. When the temperature of the raw material addition gas is 80° C. or lower, preferably 60° C. or lower, and particularly preferably 40° C. or lower, not only the deterioration of a pipe material can be prevented but also, in terms of safety, a burn can be prevented even when the pipe is touched by hands. Further, as the raw material powder is not exposed to unnecessary high temperature, a molded magnet with stable quality can be obtained.

(2j-2) Pressure of Raw Material Addition Gas

Pressure of the raw material addition gas is not particularly limited, if it is within the range in which the working effect of the present embodiment is not inhibited. As a general standard, pressure of the raw material addition gas is preferably the same or higher than that of the primary carrier gas 14.

(2j-3) Flow Rate and Flow Amount of Raw Material Addition Gas

Flow rate of the raw material addition gas is not particularly limited, if it is within the range in which the working effect of the present embodiment is not inhibited. As for the flow amount of the raw material addition gas, it is important that the gas temperature is not unnecessarily high according to the flow amount ratio compared to the primary carrier gas. The flow amount ratio (flow amount of primary carrier gas/flow amount of raw material addition gas) is preferably controlled to 1 to 7, and more preferably 2 to 5 or so. When the flow amount ratio is 7 or less, troubles like clogging of a nozzle or a pipe caused by excessive supply of the raw material powder can be reduced. When it is 1 or higher, the deterioration in properties of the raw material powder, which is caused by a contact with the primary carrier gas at high temperature, can be suppressed.

(2j-4) Mixing of Raw Material Addition Gas and Primary Carrier Gas (High Speed Carrier Gas)

In the present embodiment, for adding the raw material powder to the primary carrier gas as raw material addition gas, the raw material addition gas from the raw material powder supplying unit 17 can be added to the carrier gas accelerating unit 15 via the pipe 16. As for the addition amount of the raw material powder to the primary carrier gas (it is also possible to add directly to high speed carrier gas), an excessively small amount is not favorable in terms of economics, and an excessively large amount may yield clogging. The suitable addition amount can be chosen to have optimum adhesion speed on a substrate in view of the balance with the gas flow amount.

(2j-5) Supply Amount of Raw Material Powder

Further, the supply amount of the raw material powder is not particularly limited, if it is within the range in which the working effect of the present embodiment is not inhibited. As a general standard, the supply amount of the raw material powder is in the range of 1 to 100g/min, preferably 5 to 20g/min, and more preferably 8 to 10.5 g/min. However, it is not limited to those ranges, and as long as it is within the range in which the working effect of the present embodiment is not inhibited, it is needless to say that those outside the range are also included in the technical scope of the present embodiment. When the supply amount of the raw material powder is 1 g/min or more, the productivity is relatively good so that the desired film thickness can be obtained in a short time. Further, although it may vary depending on mixing ratio with the carrier gas for preparing the raw material addition gas, at spraying to the substrate B, the particles are not bounced together with the high speed carrier gas after collision to the substrate B due to excessively high speed of the raw material powder. For such reasons, it is favorable in that collision and adhesion on the substrate B followed by deposition can be achieved. When the supply amount of the raw material powder is 100 g/min or less, there is a merit that troubles like nozzle clogging can be reduced. Further, although it may vary depending on mixing ratio with the carrier gas for preparing the raw material addition gas, the speed of the raw material powder is not lowered at spraying to the substrate B, and thus it is favorable in that ultrahigh speed collision and adhesion on the substrate B together with the high speed carrier gas can be made followed by deposition.

(2j-6) Mixing Ratio of Primary Carrier Gas and Raw Material Addition Gas

Mixing ratio of primary carrier gas and raw material addition gas is not particularly limited, if it is within the range in which the working effect of the present embodiment is not inhibited. As a general standard for the mixing ratio of primary carrier gas and raw material addition gas, the raw material addition gas is in the range of 1 to 7 parts by volume, and preferably 2 to 5 parts by volume compared to 100 parts by volume of the primary carrier gas. However, it is not limited to those ranges, and as long as it is within the range in which the working effect of the present embodiment is not inhibited, it is needless to say that those outside the range are also included in the technical scope of the present embodiment. When the raw material addition gas is 1 part by volume or more compared to 100 parts by volume of the primary carrier gas, deterioration of the raw material addition gas caused by contact with the high temperature primary carrier gas can be suppressed. Further, as there is no problem that the raw material powder exceeds the desired particle speed and collides in solid phase state to the substrate B to yield crushing or no deposition due to bouncing, the film can be favorably formed by collision and deposition. It is also favorable in that a thick magnet film with higher density can be obtained by solidification molding as a result of repeating those operations. When the raw material addition gas is 7 parts by volume or less compared to 100 parts by volume of the primary carrier gas, troubles like clogging of a nozzle or a pipe caused by excessive supply of the raw material powder can be reduced. Further, the film can be formed by collision and deposition of the raw material powder, together with the high speed carrier gas, to a substrate at a desired particle speed (ultrahigh speed) while it remains in a solid phase state. It is also favorable in that a thick magnet film with higher density can be obtained by solidification molding by repeating those operations.

### (2k) High Speed Carrier Gas

The high speed carrier gas used in the present embodiment is prepared by mixing the raw material addition gas and the primary carrier gas and accelerating them in the carrier gas accelerating unit 17.

(2k-1) Flow Rate of High Speed Carrier Gas

In the present embodiment, flow rate of the high speed carrier gas is accelerated, in the carrier gas accelerating unit 17, to 600 m/s or more, preferably to 700 m/s or more, more preferably to 1000 m/s or more, belonging to the region of sound speed, and particularly preferably to high speed range of 1000 to 1300 m/s. When the high speed carrier gas is 600 m/s or more, a film can be formed by, at desired particle speed, collision and adhesion of the raw material powder remained in a solid phase state to a substrate according to a cold spray method. Further, by repeating those operations, deposition can be preferably made on a substrate, and thus it is favorable in that a desired molded magnet (product in mm unit) with higher density and excellent magnetic properties (coercive force, residual magnetic flux density, and tight adhesion) can be molded by solidification. When the high speed carrier gas is 1300 m/s or less, there is no problem that the substrate surface is shaven by the magnet powder (raw material powder), and the raw material powder exceeds the desired particle speed and collides in solid phase state to the substrate B to yield crushing or no-deposition as a result of bouncing. Accordingly, the film can be favorably formed by collision and deposition on a substrate. It is also favorable in that a molded magnet with higher density and excellent magnetic properties (coercive force, residual magnetic flux density, and tight adhesion) can be obtained by solidification molding as a result of repeating those operations. Meanwhile, the high speed carrier gas is prepared as high temperature and high pressure carrier gas (primary carrier gas) after passing through the carrier gas generating unit 11 and the heater for heating carrier gas 13 until it is introduced to the carrier gas accelerating unit 17.

### (2l) High Speed Spray of High Speed Carrier Gas Toward Substrate

In the present embodiment, according to high speed spray of the high speed carrier gas from the carrier gas accelerating unit 17 toward a substrate placed (fixed) on the substrate holding unit 19, a film is formed as a result of collision and adhesion on the substrate, and also according to deposition and solidification molding, a desired molded magnet is obtained. As a result, a molded magnet having excellent magnetic properties (in particular, coercive force, residual magnetic flux density, and tight adhesion) due to increased film thickness and high density can be obtained.

(2l-1) Particle Speed (Spray Speed)≅Collision Speed on Substrate B

According to the present embodiment, the raw material powder is sprayed (at high speed) with the carrier gas under atmospheric pressure from the nozzle tip of the carrier gas accelerating unit 17 (nozzle gun), and collided and bound (adhered) on the substrate B for deposition, thereby a deposit (=molded magnet) is molded by solidification. As for the speed (spray speed) at (high speed) spraying of the raw material powder with carrier gas=collision speed on substrate B (herein below, simply referred to as particle speed), it is not particularly limited, if it is within the range in which the working effect of the present embodiment is not inhibited. The particles speed for high speed spray of the raw material powder with the carrier gas is accelerated to 600 m/s or more, preferably to 700 m/s or more, more preferably to 1000 m/s or more, belonging to the region of sound speed, and particularly preferably to ultrahigh speed range of 1000 to 1300 m/s. When the particle speed is 600 m/s or more, a film can be formed by, at desired particle speed, collision and adhesion of the raw material powder remained in a solid phase state to a substrate according to a cold spray method, because the raw material powder does not lose its speed by air resistance under atmospheric pressure. Further, by repeating those operations, deposition can be preferably made on a substrate, and thus it is favorable in that a desired deposit (=molded magnet; in mm unit) with higher density and excellent magnetic properties (coercive force, residual magnetic flux density, and tight adhesion) can be molded by solidification. When the particle speed is 1300 m/s or less, it is favorable in that the ultrahigh speed can be maintained without suppressing part of the elaborately obtained kinetic energy as caused by an occurrence of friction sound by exceeding the speed of sound from spray to collision. Further, the substrate surface is not shaven by the magnet powder (raw material powder) and there is no bouncing of the raw material powder after collision to the substrate as caused by excessively high particle speed of the raw material powder at the time of spraying to the substrate B. There is also no problem that the raw material powder exceeds the desired particle speed and collides in solid phase state to the substrate B to yield crushing or no-deposition as a result of bouncing. Accordingly, the film can be favorably formed by collision and deposition on the substrate B. It is also favorable in that a molded magnet with higher density and excellent magnetic properties (coercive force, residual magnetic flux density, and tight adhesion) can be obtained by solidification molding as a result of repeating those operations.

(2l-2) Atmosphere of Spray Region

The reason of having atmospheric pressure (environment of atmospheric pressure) for the spray region from the nozzle tip of the carrier gas accelerating unit 17 (nozzle gun) to the substrate B in the present embodiment is to solve the problems associated with AD method, which is conventionally performed under reduced pressure (see, section of “Problems to be Solved by the invention”). In addition, by having the spray region under atmospheric pressure, the raw material powder (rare-earth magnet powder) which has been collided and bound (adhered) on the substrate B can yield quick heat transfer from the substrate B to substrate holding unit 19 having a large surface area, and thus it is favorable in terms of achieving solidification molding while having heat removal=release of heat to atmosphere for obtaining a molded magnet with suppressed deterioration in magnetic properties.

### (2m) Temperature of High Speed Carrier Gas

The present embodiment is characterized in that the temperature of the high speed carrier gas is set below the decomposition temperature of the nitride of rare-earth magnet powder (raw material powder). Herein, the temperature of the high speed carrier gas indicates the temperature at the time of high speed spray (specifically, right before spraying) toward the substrate B from the nozzle tip of the carrier gas accelerating unit 17 (nozzle gun), and it can be measured by the temperature sensor 8b installed on the nozzle tip of the carrier gas accelerating unit 17 (nozzle gun). By having the temperature of the high speed carrier gas lower than the decomposition temperature of nitride, a method for producing a magnet satisfying simultaneously the film thickening, high density, and improved magnetic properties (in particular, coercive force, residual magnetic flux density, and tight adhesion) can be provided without lowering the magnetic properties of magnet powder, and thus a desired molded magnet (bulk molded product) can be obtained (compare Examples 1 to 19 to Comparative Example 4 in Table 1 for reference). Also for a case in the rare-earth magnet powder (raw material powder) contains a nitride, temperature of the high speed carrier gas varies depending on type (material) of the rare-earth magnet powder (raw material powder), and thus it cannot be defined uniquely. For example, when the rare-earth magnet R-M-X is Sm—Fe—N, more specifically Sm₂Fe₁₄Nₓ (x=2 to 3) (see, Examples 1 to 19), decomposition occurs at 450° C. or higher. From this point of view, the temperature of the high speed carrier gas is the same or higher than 100° C. but lower than 450° C., preferably in the range of 150 to 400° C., more preferably 170 to 380° C., and particularly preferably 200 to 350° C. (compare Examples 1 to 19 to Comparative Example 4 for reference). When the temperature of the high speed carrier gas is the same or higher than 100° C., adhesion easily occurs upon collision to a substrate and also the productivity is excellent, and therefore preferable. Further, when the temperature of the high speed carrier gas is less than 450° C., decomposition of the rare-earth magnet (raw material powder)=nitride can be suppressed, and thus it is favorable in terms of suppressing the deterioration of the magnetic properties (in particular, coercive force, residual magnetic flux density; see Comparative Example 4). However, the present embodiment is not limited to that range, and the optimum temperature of the high speed carrier gas can be suitably determined for each type (material) of the rare-earth magnet (raw material powder) within a range in which the working effect of the present embodiment is not inhibited. Herein, when the rare-earth magnet (raw material powder) contains a nitride, the decomposition temperature of nitride was specified based on DSC (differential scanning calorimetry) analysis. For example, when decomposition of the raw material powder occurs at 450° C. or higher, decomposition temperature of the rare-earth magnet (raw material powder)=nitride (decomposition start temperature) is 450° C.

Meanwhile, when the rare-earth magnet powder (raw material powder) contains a nitride, the decomposition temperature of the nitride (nitrogen compound) is generally 520 to 530° C. in nitride-based rare-earth magnet powder other than those exemplified above. Accordingly, the temperature of the high speed carrier gas is lower than the decomposition temperature. Higher energy can be given to magnet powder (raw material powder) as the temperature of the high speed carrier gas increases. For such reasons, at the temperature below the decomposition temperature of a nitrogen, the nitride particles (in particular, near surface) will not decompose even for a short time, and thus it is preferable in that the desired magnetic properties can be effectively exhibited. Temperature of the high speed carrier gas is preferably 500° C. or less, more preferably in the range of 100 to 500° C., even more preferably 100 to 400° C., and particularly preferably 200 to 300° C. When it is 100° C. or higher, adhesion and deposition on a substrate can be achieved, and thus it could be desirable in terms of the productivity. Meanwhile, when the temperature of the high speed carrier gas is a temperature=780° C. that is the same or higher than the decomposition temperature of the nitride, it is found that the coercive force and residual magnetic flux density as the magnetic properties are extremely deteriorated (significantly worsened), that is, to 0.21 and 0.27, respectively, as shown in Comparative Example 4. Based on that, it can be said that, in the present embodiment, it may be preferable to perform the solidification molding while the temperature of the high speed carrier gas is set below the decomposition temperature of the nitride.

As described herein, temperature of the high speed carrier gas indicates the temperature of the accelerated high speed carrier gas containing the raw material powder as described above. In the specification, carrier gas before heating is referred to as low temperature gas, heated carrier gas before adding the raw material powder is referred as primary carrier gas, and gas for supplying the raw material powder at room temperature is referred to as raw material addition gas, so as to distinguish them from the high speed carrier gas (see, FIG. 1). Temperature of the high temperature carrier gas corresponds to the temperature of the mixture of the primary carrier gas heated by the heater for heating carrier gas 13 and the raw material addition gas. Temperature adjustment can be made based on gas pressure ratio between the primary carrier gas and the raw material addition gas. Meanwhile, with regard to the gas pressure ratio between the primary carrier gas and the raw material addition gas required for achieving the carrier gas temperature, conditions (gas pressure ratio) are desirably determined in advance based on a trial and error with preliminary test or the like while monitoring the temperature. That is because it varies as the nozzle diameter of the cold spray apparatus in use is changed or type of the gas or temperature of the gas is changed.

Meanwhile, the temperature of the high speed carrier gas which is sprayed in a mixture state with the raw material powder has an influence on temperature of the substrate. The magnet formed as a film on the substrate B (film→thick film) is exposed to the gas temperature for a long period of time, and if the temperature of the high speed carrier gas is excessively higher than the temperature conditions described above, it may cause a deterioration of the magnetic properties. Meanwhile, even when the temperature of the high speed carrier gas is within the temperature range defined above, slow cooling (water cooling or air cooling) can be performed, if required. It is also possible to stabilize the temperature of a magnet formed as a film on the substrate B (film→thick film) by using the substrate holding unit 19 having good heat absorbing property.

### (2n) Solidification Molding of Molded Magnet on Substrate by Ultrahigh Speed Spray of Raw Material Powder

In the present embodiment, a molded magnet is molded by solidification on a substrate in accordance with ultrahigh speed spray of the raw material powder. At that time, the space (distance) between the carrier gas accelerating unit 17 (tip of the nozzle gun) and a surface of the substrate B placed on the substrate holding unit 19 is set (arranged) to have a constant interval between them. Further, by using a movable (scanning) nozzle gun as the carrier gas accelerating unit 17, nozzle tip of the nozzle gun enables scanning at constant speed in a direction parallel (up and down direction and right and left direction) to the substrate B, and thus an even film can be formed on the entire region or any part (certain region) of the substrate.

(2n-1) Scanning Speed of Gas Nozzle when Nozzle Gun is Used

When a movable (scanning) nozzle gun is used as the carrier gas accelerating unit 17, scanning speed of the gas nozzle is not particularly limited, if it is within the range in which the working effect of the present embodiment is not inhibited. As described herein, the nozzle gun indicates a nozzle gun which is equipped with a nozzle for spraying carrier gas containing the raw material powder, and according to scanning the nozzle against the substrate B, it enables obtainment of a thick film with growth of a film. The scanning speed of such a gas nozzle is preferably in the range of 1 to 500 mm/s, more preferably 10 to 200 mm/s, and particularly preferably 50 to 100 mm/s. When the scanning speed of a gas nozzle is 1 mm/s or more, the heating region is prepared uniformly so that a film with good adhesion property is obtained, and also film thickening can be achieved without lowering the production efficiency, and therefore favorable. Further, since the straightness increases as the scanning becomes slower, it is advantageous in that it is economically favorable as scattering of the raw material powder to a peripheral region of the substrate is prevented and also even film thickness is achieved all over the substrate. When the scanning speed of a gas nozzle is 500 mm/s or less, heterogeneity caused by uneven spray can be suppressed and also, by having excellent production efficiency (productivity), production cost can be reduced in accordance with large size production of a thick magnet film. It is also possible to form a film of magnet with very high film thickness by increasing pass number as the scanning speed increases, and it is also advantageous from the viewpoint of efficient forming of a thick magnet film with extremely large size. For such reasons, it is advantageous in terms of a being a technique fully applicable for a field which requires a very large and thick film, such as a motor for driving an electric vehicle.

(2n-2) Film Thickening Mode (1) Using Scanning Type Nozzle Gun=Multilayer Structure

Further, for film thickening by using a movable (scanning) nozzle gun as the carrier gas accelerating unit 17, by repeatedly performing several times the aforementioned parallel (up and down direction and right and left direction) scanning (moving or operating), a desired thick film can be prepared. In other words, when film thickness formed by single parallel (up and down direction and right and left direction) scanning (moving or operating) is 20 μm, fifty times of the parallel (up and down direction and right and left direction) scanning (moving or operating) can be performed over an entire surface of substrate for solidification molding of a 1000 μm molded magnet.

At that time, when a bilayer structure of a rare-earth magnet with different kind is prepared for a 1000 μm molded magnet, twenty-five times of the parallel (up and down direction and right and left direction) scanning (moving or operating) are performed over an entire surface of substrate by using the raw material powder for the first layer. After that, by using the raw material powder for the second layer, twenty-five times of the parallel (up and down direction and right and left direction) scanning (moving or operating) are performed over an entire surface of substrate so that a molded magnet with a bilayer structure in which each film has thickness of 500 m can be formed. Similarly, a molded magnet with a multilayer structure of a rare-earth magnet with different kind for each layer can be achieved while the thickness of each film is optionally modified.

(2n-3) Film Thickening Mode (2) Using Scanning Type Nozzle Gun=Fractionated Structure

Further, for forming a molded magnet of a rare-earth magnet with different kind between the right and left side of a substrate, two movable nozzle guns are used, for example, and by using one of the movable nozzle guns, fifty times of the parallel (up and down direction and right and left direction) scanning (moving or operating) are performed over the right half of a substrate surface. Simultaneously, by using the other movable nozzle gun, fifty times of the parallel (up and down direction and right and left direction) scanning (moving or operating) are performed over the left half of a substrate surface. At that time, by using different kind of the raw material powder (rare-earth magnet) for each of the two movable nozzle guns, a molded magnet of a rare-earth magnet with different kind between the right and left side can be formed without unevenness or irregularities such as a step in a joint between the right and left. With an application of such operations, a molded magnet in which plural molded magnets of a rare-earth magnet with different kind are used in combination can be formed on a substrate. Specifically, when the substrate is divided into 16 sections in lattice, a molded magnet with divided structure based on use of a rare-earth magnet with different kind for each of the 16 divided (fractionated) sections can be formed. At that time, a molded magnet of a rare-earth magnet with different type can be formed continuously. However, if required, it is also possible that individually separated 16 kinds of a molded magnet are formed while a molded magnet is not formed on a top of the lattice line for having 16 divisions (fractions). In other words, a molded magnet can be formed and arranged non-continuously, that is, in a so-called stepping stone manner. According to such a technique, the molded magnet optimized to specific use can be suitably arranged only on the required areas.

(2n-4) Film Thickening Mode (3) Using Scanning Type Nozzle Gun=Multilayer+Fractionated Structure

It is also possible to form a molded magnet of a rare-earth magnet with three-dimensionally different kind by combining the aforementioned technique for forming a molded magnet with multilayer structure and the technique for forming a molded magnet with divided structure. It is also possible that the movable nozzle gun moves or operates also in a direction perpendicular to the whole surface of a substrate (front and rear direction). It is to correct even a slight amount of change in space (distance) between tip of the movable nozzle gun and the whole substrate surface, when a molded magnet with thickness of 2 mm (2000 μm) or so is formed, for example. Accordingly, the space (distance) between tip of the movable nozzle gun and the whole substrate surface can be always maintained at almost the same level, and thus it is favorable in that further uniformity of density in thickness direction and high density of molded magnet can be achieved.

(2n-5) Film Thickening Mode Using Scanning Type Substrate Holding Unit

Contrary to the descriptions given above, it is also possible that the space (distance) between tip of the fixed nozzle gun of the carrier gas accelerating unit 17 and a surface of the substrate B placed on the movable (scanning) substrate holding unit 19 is placed (arranged) with a constant interval. In such a case, the movable substrate holding unit 19 scans (moves or operates) at constant speed in a direction parallel (up and down direction and right and left direction) to the tip of the fixed nozzle gun of the carrier gas accelerating unit 17. Accordingly, the substrate placed on the movable (scanning) substrate holding unit 19 also scans (moves or operates) in the same manner, and thus an even film can be formed on the entire region or any part (certain region) of the substrate with large area.

(2n-6) Film Thickening Mode (1) Using Scanning Type Substrate Holding Unit=Multilayer Structure

Further, for film thickening by using the movable substrate holding unit 19, by repeatedly performing several times the aforementioned parallel (up and down direction and right and left direction) move (operation), a desired thick film can be prepared. In other words, when film thickness formed by single parallel (up and down direction and right and left direction) scanning (moving or operating) is 20 μm, fifty times of the parallel (up and down direction and right and left direction) scanning (moving or operating) of the movable substrate holding unit 19 can be performed against the tip of the nozzle gun for solidification molding of a 1000 μm molded magnet.

At that time, when a bilayer structure of a rare-earth magnet with different kind is prepared for a 1000 μm thick molded magnet by using the movable substrate holding unit 19, the same procedures as the movable nozzle gun can be performed. For example, twenty-five times of the parallel (up and down direction and right and left direction) scanning (moving or operating) are performed over an entire surface of substrate by using the raw material powder for the first layer. After that, by using the raw material powder for the second layer, twenty-five times of the parallel (up and down direction and right and left direction) scanning (moving or operating) are performed over an entire surface of substrate so that a molded magnet with a bilayer structure in which each film has thickness of 500 μm can be formed. Similarly, a molded magnet with a multilayer structure of a rare-earth magnet with different kind for each layer can be achieved while the thickness of each film is optionally modified.

(2n-7) Film Thickening Mode (2) Using Scanning Type Substrate Holding Unit=Fractionated Structure

Further, for forming a molded magnet of a rare-earth magnet with different kind between the right and left side of a substrate by using the movable substrate holding unit 19, the same procedures as the case in which the carrier gas accelerating unit 17 is a movable nozzle gun can be performed. For example, two fixed nozzle guns are used, for example, and by using one of the nozzle guns, fifty times of the parallel (up and down direction and right and left direction) scanning (moving or operating) of the movable substrate holding unit 19 are performed for covering the right half of a substrate surface. Simultaneously, by using the other nozzle gun, fifty times of the parallel (up and down direction and right and left direction) scanning (moving or operating) of the substrate holding unit 19 are performed for covering the left half of a substrate surface. At that time, by using different kind of the raw material powder (rare-earth magnet) for each of the two fixed nozzle guns, a molded magnet of a rare-earth magnet with different kind between the right and left side can be formed without unevenness or irregularities such as a step in a joint between the right and left. With an application of such operations, a molded magnet in which plural molded magnets of a rare-earth magnet with different kind are used in combination can be formed on a substrate. Specifically, when the substrate is divided into 16 sections in lattice, a molded magnet with divided structure based on use of a rare-earth magnet with different kind for each of the 16 divided (fractionated) sections can be formed. At that time, a molded magnet of a rare-earth magnet with different type can be formed continuously. However, if required, it is also possible that individually separated 16 kinds of a molded magnet are formed while a molded magnet is not formed on a top of the lattice line for having 16 divisions (fractions). In other words, a molded magnet can be formed and arranged non-continuously, that is, in a so-called stepping stone manner. According to such a technique, the molded magnet optimized to specific use can be suitably arranged only on the required areas.

(2n-8) Film Thickening Mode (3) Using Scanning Type Substrate Holding Unit=Multilayer+Fractionated Structure

It is also possible to form a molded magnet of a rare-earth magnet with three-dimensionally different kind by combining the aforementioned technique for forming a molded magnet with multilayer structure and the technique for forming a molded magnet with divided structure. It is also possible that the movable substrate holding unit 19 moves or operates also in a direction perpendicular to the tip of nozzle gun (front and rear direction). It is to correct even a slight amount of change in space (distance) between tip of the fixed nozzle gun and the whole surface of the substrate B on the movable substrate holding unit 19, when a molded magnet with thickness of 2 mm (2000 μm) or so is formed, for example. Accordingly, the space (distance) between tip of the fixed nozzle gun and the whole surface of the substrate B on the movable substrate holding unit 19 can be always maintained at almost the same level, and thus it is favorable in that further uniformity of density in thickness direction and high density of molded magnet can be achieved.

(2n-9) Film Thickening Mode in which Scanning Type Nozzle Gun and Scanning Type Substrate Holding Unit are Used in Combination

It is also possible that the nozzle gun of the carrier gas accelerating unit 17 and the substrate holding unit 19, both in movable (scanning) type, are used in combination. This is the same principles as an ink-jet printer in which a nozzle gun (=ink-jet part) of the carrier gas accelerating unit 17 on one side is scanned (moved or operated) only in the right and left direction: X axis direction of the substrate surface (right and left direction: X axis direction, and up and down direction: Y axis direction). It is a constitution in which the substrate holding unit 19 (=print paper) on the other side is scanned (moved or operated) only in the up and down direction: Y axis direction of the substrate surface. By having a constitution (structure) in which the nozzle gun of the carrier gas accelerating unit 17 and the substrate holding unit 19 are associated (synchronous) with each other, it is favorable in that a desired molded magnet can be obtained by relatively simple operations and control. Meanwhile, with those constitutions, the aforementioned molded magnet having a multilayer structure can be formed and also a molded magnet with a divided structure can be obtained. It is also possible to form a molded magnet of a rare-earth magnet with three-dimensionally different kind by combining the aforementioned technique for forming a molded magnet with multilayer structure and the technique for forming a molded magnet with divided structure.

The above corresponds to descriptions of the second embodiment of the present invention, and in other words, it can be a method for producing a molded magnet including the following steps (1) and (2). Specifically, it includes a spraying step (1) in which a raw material powder containing nitride is mixed with carrier gas and the raw material powder is sprayed with high speed carrier gas in an accelerated state, and a solidification molding step (2) in which the sprayed raw material powder is deposited on a substrate for solidification molding. Further, in the present embodiment, the raw material powder contains nitride-based rare-earth magnet powder and Zn and/or Mn particles. In addition to them, the present embodiment relates to a method of producing a molded magnet characterized in that the temperature of the high speed carrier gas at the spraying step (1) is lower than the decomposition temperature of the nitride, and the solidification molding step (2) is performed under atmospheric pressure. Herein below, descriptions are given for those requirements.

The spraying step (1) in which raw material powder containing nitride is mixed with carrier gas and sprayed using high speed carrier gas in an accelerated state

According to the spraying step of the present embodiment, carrier gas, nitride, and the raw material powder are mixed and the raw material powder is sprayed using high speed carrier gas in an accelerated state. With regard to the aforementioned cold spray apparatus, it is preferable that the raw material powder is sprayed with high speed carrier gas, which is in an accelerated state after mixing the carrier gas and the raw material powder (=the raw material powder is neither melted nor gasified but controlled to have pre-determined temperature, pressure, and speed). For spraying, the raw material powder is sprayed with high speed carrier gas, without melting or gasification of the raw material, with the carrier gas at ultrahigh speed from tip of a spray nozzle of a nozzle gun toward a substrate while the raw material powder remains in a solid phase state. Since the spraying step of the present embodiment is the same as those described in whole context of (1) and (2a) to (21-1) of the embodiment (B), no further descriptions are given herein.

The solidification molding step (2) for solidification molding by depositing sprayed raw material powder on substrate

The solidification molding step of the present embodiment is for solidification molding by depositing on a substrate the raw material powder which has been sprayed in the above spraying step (1). Preferably, the raw material powder sprayed in the above spraying step (1), remaining in a solid phase state, is collided and adhered to a substrate at ultrahigh speed with a carrier gas to form a film with high density, and by repeating those operations, the raw material powder is deposited on the substrate, and as a result, a thick deposit film with high density and excellent magnetic properties is molded by solidification. Accordingly, a molded magnet with high density and excellent magnetic properties (coercive force, residual magnetic flux density, and tight adhesion) can be obtained. Since the solidification molding step of the present embodiment is the same as those described in whole context of (1) and in (2n) or the like of the embodiment (B), no further descriptions are given herein.

### (3) Raw Material Powder, Temperature of Carrier Gas, and Under Atmospheric Pressure

As for the material powder used in the present embodiment, temperature of the high speed carrier gas at the aforementioned spraying step (1), and operating the solidification molding step (2) under atmospheric pressure, since they are the same as those described in detail in (2e) to (2i), (2l-2), (2m) or the like of the embodiment (B), no further descriptions are given herein.

### (4) Gas Pressure at Spraying Step

Gas pressure at above (1) spraying step of the present embodiment is not particularly limited, as long as the working effect of the present embodiment is not inhibited. However, if the gas pressure at spraying step is excessively low, the particles collided on a substrate may not sufficiently adhered thereon, and thus the solidification molding is desirably carried out with spraying at gas pressure of more than 0.5 MPa, and preferably 0.6 MPa or more. The reason of having gas pressure of more than 0.5 MPa, and preferably 0.6 MPa or more is that, when it is below 0.5 MPa, a decrease in particle speed is significant so that the film growth may become difficult By having the gas pressure within the above range, it is possible to provide a method for producing a magnet satisfying simultaneously the film thickening, high density, and improved magnetic properties (in particular, excellent residual magnetic flux density) can be provided without lowering the magnetic properties of magnet powder, and thus a desired molded magnet (bulk molded product) can be obtained. As described herein, the gas pressure indicates pressure at spraying step before atmosphere opening, and it can be measured with the aforementioned pressure sensor 8a. The carrier gas pressure is in balance with temperature of the carrier gas. When the pressure is excessively low, deposition cannot be made by collision and adhesion to the substrate B even when the temperature is increased as much as possible. Further, upper limit of the gas pressure varies depending on compatibility with the substrate B. Even under the same pressure, it may function to shave the substrate, to cause bouncing on the substrate, or to yield desirable deposition on a substrate. For example, even under the gas pressure at which collision and adhesion to the substrate is made and desirable deposition on the substrate is made when a Cu plate is used as a substrate, if an Al plate is used instead as a substrate, it may function to shave the substrate. From this point of view, although the gas pressure cannot be defined uniquely, pressure of the carrier gas is sufficiently more than 0.5 MPa, preferably 0.6 MPa or more, more preferably in the range of 0.6 to 5 MPa, and particularly preferably 0.8 to 3 MPa. Meanwhile, even if the pressure is not within the range, when no adverse effect is exhibited on the working effect of the present embodiment and the working effect of the present embodiment is suitably exhibited, it can be included in the scope of the present embodiment Gas pressure of more than 0.5 MPa is preferable in that a molded magnet with high density and excellent magnetic properties (coercive force, residual magnetic flux density, tight adhesion=peeling strength) can be obtained according to growth of a film without causing a reduction in particle speed at ultrahigh speed.

(5) with Regard to the Characteristics of the Second Embodiment

As described above, in the present embodiment, a cold spray method, that is, a method for forming a film in which the raw material powder is added without being melted or gasified to high speed carrier gas so that the raw material powder remained in a solid phase state is collided, together with carrier gas, to a substrate at ultrahigh speed, is used. Compared to a thermal spray method or a plasma thermal spray method of a related art, the cold spray method allows processing at a temperature lower than the melting point of materials, and thus it is classified as a low temperature process like aerosol deposition (AD) method. However, acceleration method of gas in the cold spray is different from AD method. Unlike the AD method in which gas accelerating method is based on lowering the pressure in vacuum chamber, the cold spray method is characterized in that the acceleration is made by heating carrier gas. Thus, while particle speed faster than the AD method is obtained, it is characterized in that the raw material powder is inevitably heated to a temperature of the same or higher than room temperature. In addition, as further acceleration of particle speed can be obtained as the carrier gas temperature increases, compared to the temperature for thermal spray, which is generally higher than 1000° C., it could be a solidification molding technique with a low temperature range. However, there is a problem that it is still several hundred degrees. For such reasons, although the cold spray method is used as a method for coating metal having high melt temperature, a hard material, or ceramics, there is an advantage that a change in the characteristics of any materials is small in the original temperature range for cold spray method. However, for a material showing a great change in characteristics against heat of 400° C. or more like the magnet powder for bonding used for the present embodiment (including the variation example), an operation at further lower temperature is necessary. Accordingly, when spray is performed after lowering the temperature of carrier gas, collision speed of particles to a substrate is lowered, and thus a problem of not having the film growth has occurred as they are not adhered onto the substrate. On the other hand, when the temperature of carrier gas is increased, the magnetic properties are deteriorated and also hard and brittle materials such as magnet material are excessively accelerated and the magnet particles function as abrasives, and as a result, there is a problem that the substrate is shaved and no film is formed as a magnet. As such, we tried to improve those problems. As a result, it was found that, in raw material powder of rare-earth magnet, by having the carrier gas temperature lower than the particle growth temperature of crystal particles of a rare-earth magnet, deterioration of magnetic properties can be prevented and film growth can be possibly achieved.

### (C) Magnet Motor

### Third Embodiment

The magnet motor of the present invention is characterized in that it is obtained by using at least one molded magnet obtained by selection from a group consisting of a molded magnet described in the first embodiment and a molded magnet obtained by the production method described in the second embodiment (including the variation example). Specifically, in the magnet motor of the present invention, only one kind of the molded magnet of the first embodiment and the second embodiment can be used, or two or more kinds of them can be used in combination. Since the magnet motor of the present embodiment is a magnet motor characterized by using at least one kind of a molded magnet of the first embodiment and the second embodiment (e.g., those for small home appliances or surface magnets), it is favorable in that the equivalent characteristics can be obtained from a light, small-sized, and high performance system.

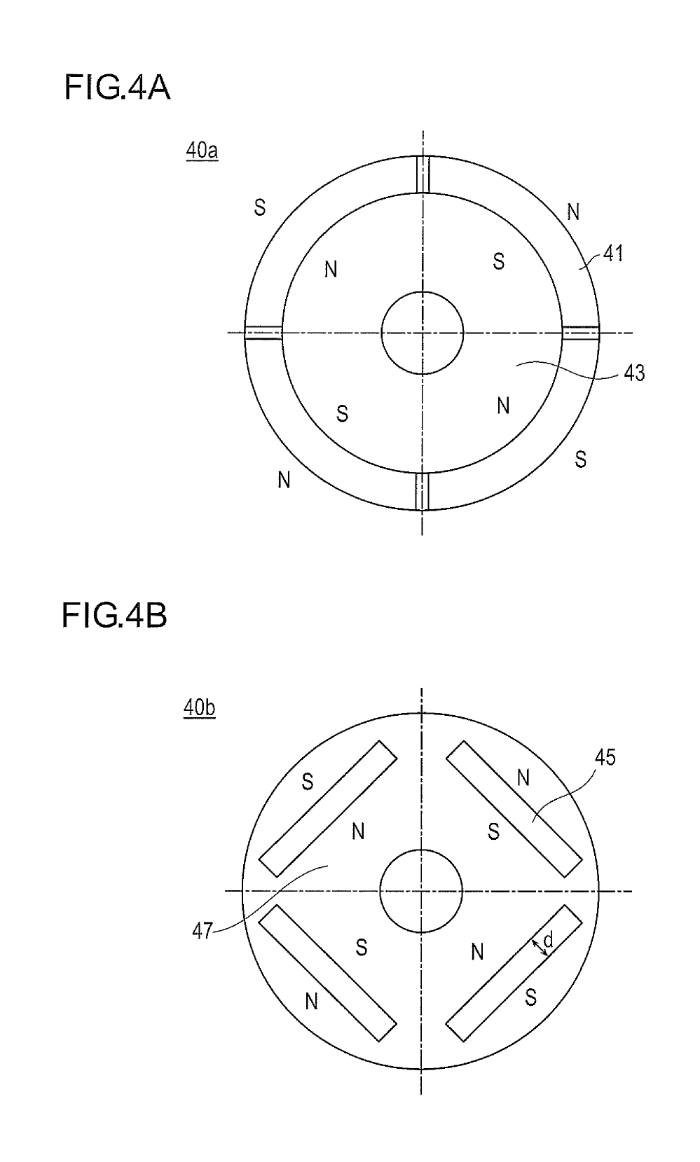

FIG. 4A is a schematic cross-sectional view illustrating diagrammatically the rotor structure of a surface permanent magnet synchronous motor (SMP or SPMSM). FIG. 4B is a schematic cross-sectional view illustrating diagrammatically the rotor structure of an internal permanent magnet synchronous motor (IMP or IPMSM). In the surface permanent magnet synchronous motor 40a illustrated in FIG. 4A, at least one kind of the magnet (molded product) 41 of the first embodiment and the second embodiment is directly molded (or attached) by solidification on a surface of the rotor 43 for a surface permanent magnet synchronous motor. In the surface permanent magnet synchronous motor 40a, as described in the first embodiment and the second embodiment, by using the rotor 43 as a substrate, the raw material powder is directly sprayed on the rotor 43 and adhered and deposited for solidification molding to form the molded magnet 41 on the surface permanent magnet synchronous motor 40a. According to magnetization of the molded magnet 41, the surface permanent magnet synchronous motor 40a can be obtained. That could be better than the internal permanent magnet synchronous motor 40b. In case of direct solidification molding, in particular, it is favorable in that the molded magnet 41 is not peeled from the rotor 43 even under high speed rotation with centrifugal force, and thus it can be easily used. Meanwhile, in the internal permanent magnet synchronous motor 40b illustrated in FIG. 4B, at least one kind of the magnet (molded product) 45 of the first embodiment and the second embodiment is added under pressure (inserted) to an internal groove formed on the rotor 47 for an internal permanent magnet synchronous motor followed by fixing. In the internal permanent magnet synchronous motor 40b, as described in the first embodiment and the second embodiment, a substrate having the same surface shape as the internal groove (illustrated figure) is used, the raw material powder is sprayed on a substrate until it has the same thickness d as the internal groove, and according to adhesion and deposition on a substrate, the molded magnet 45 is obtained by solidification molding. Alternatively, a substrate having the same surface shape as the internal groove (illustrated figure) is used, the raw material powder is sprayed on a substrate until it has the thickness d which is 1/10 of the internal groove, and according to adhesion and deposition on a substrate, 10 sets of the molded product 45a are produced by solidification molding. At that time, the substrate and molded product 45, 45a are closely adhered (integrated). Next, the magnet (molded product) 55, 55a is removed from the substrate surface (which has been adhered with an extremely thin metal foil easily soluble in a solvent) is peeled by using a suitable solvent (a solvent dissolving only the metal foil on substrate) or peeled (removed) by applying physical stress to give only the molded magnet 45, 45a. Next, the molded magnet 45, 45a is magnetized and, regarding the magnet 45a, ten pieces of the molded magnet 45a are overlaid to have desired thickness d. After that, by adding under pressure (inserting) the molded magnet 45 or 45a (laminate of 10 pieces) to the internal groove of the rotor 47, the internal permanent magnet synchronous motor 40b can be obtained. In such a case, having the molded magnet 45, 45a in a plate shape is favorable in that solidification molding of the molded magnet 45, 45a is easier than the surface permanent magnet synchronous motor 40a which needs solidification molding of a magnet on a curved surface. Meanwhile, the present embodiment is not limited to specific motor described above, and it can be applied to a field of broad range. In other words, it is sufficient to have a shape corresponding to various applications in a very broad range in which a rare-earth magnet is used, for example, consumer electronics field such as capstan motor of audio equipment, speaker, headphone, picking up CD, a motor for winding in a camera, actuator for focusing, a motor for driving rotary head of video equipment or like, motor for zooming, motor for focusing, capstan motor, optical pickup for DVD or Blu ray, air conditioning compressor, fan motor for outdoor unit, or a motor for electric shave; peripheral equipment for a computer and OA equipment such as voice coil motor, spindle motor, optical pickup for CD-ROM and CD-R, stepping motor, plotter, actuator for printer, dot printer print head, or rotating sensor for copying machine; precision devices in the field of measurement, communications, and others such as stepping motor for watch, various meter, pager, vibration motor for cellular phone (including portable information terminals), motor for driving recorder pen, accelerator, undulator for light radiation, polarized magnet, ion source, various plasma sources in a device for manufacturing semiconductor, electronic polarization, or magnetic inspection bias; medical fields such as permanent magnetic type MRI, electrocardiography device, electroencephalography device, dental drill motor, magnet for fixing teeth, or magnetic necklace; FA fields such as AC servo motor, synchronous motor, brake, clutch, torque coupler, linear motor for return, or lead switch; and electric components and devices of an automobile such as retarder, ignition coil transformer, ABS sensor, detection sensor for rotation or position, sensor for suspension control, door lock actuator, ISCV actuator, motor for driving electric vehicle, motor for driving hybrid vehicle, motor for driving fuel cell vehicle, brushless DC motor, AC servo motor, AC induction motor, power steering, car air conditioner, optical pick up for car navigation. However, the use in which the rare-earth magnet of the present embodiment is used is not limited at all to the aforementioned extremely small area of products (parts), and it is needless to say that it can be widely used for general applications in which the rare-earth magnet is currently used. It is also possible that, by using a substrate as a releasing material and selecting only a molded magnet which has been formed on a substrate and then peeled (removed) from the surface of a substrate, it can be used for various applications. For such a case, it is sufficient that the shape of a substrate is prepared to have a shape applicable for the use, and examples thereof include a plate (disc) shape polygon (triangle, square, trapezoid, hexagon, circular shape or the like), a wave plate polygon (triangle, square, trapezoid, hexagon, circular shape or the like), a donut shape, or the like, but not particularly limited.

### EXAMPLES

Hereinbelow, the present invention is described in greater detail by describing specific examples of the present invention.

### Example 1

Producing a molded magnet was performed by a cold spray method which uses the cold spray apparatus 10 illustrated in FIG. 1.

As the substrate B, a Cu substrate having width of 50 mm, length of 80 mm, and thickness of 1 mm was prepared. As the substrate holding unit 19, a stone slab was prepared, and as the carrier gas accelerating unit 17, a nozzle gun was prepared. Surface of the Cu substrate is fixed on the stone slab such that it is at a distance of 10 mm from nozzle tip of a nozzle gun (four corners of the substrate are fixed), and then raw material powder was sprayed toward the Cu substrate by cold spray method to grow a magnet film and perform solidification molding. As a result, a molded magnet was obtained.

As for the magnet powder in raw material powder, magnet powder for Sm₂Fe₁₄Nₓ alloy-based bond magnet was used. With regard to the particle diameter of the magnet powder, it was mainly the particle diameter of 5 μm or less as determined by SEM (scanning type electron microscope). In addition, as a result of particle size analysis, the average particle diameter was found to be 3 μm. The raw material magnetic powder (magnet powder) of Sm₂Fe₁₄Nₓ (x=2 to 3) was specified by decomposition temperature based on DSC (differential scanning calorimetry) analysis. As a result, the decomposition occurred at 450° C. or higher.

As for the magnet powder, Zn particles were blended at 15% in terms of volume ratio to yield raw material powder. As for the Zn particles, commercially available particles with average particle diameter of 7 m were used. The raw material powder consisting of magnet powder and Zn particle was mixed by stirring and then subjected to a cold spray method.

The elasto-plasticity ratio of the energy accompanied with the plastic deformation of the non-magnetic metal particles was defined as an indicator of easiness of deformation, by using a nano-indentation method. As illustrated in FIG. 2A, the nano-indentation method is a method for measuring the relation between the load P and displacement (indentation depth h into the sample 23) (indentation (load)-de-loading curve) from insertion (indentation) of the indenter 21, which is a diamond triangular pyramid, to certain load onto a surface of the sample 23 (non-magnetic metal plate) placed on an appropriate base (not illustrated) to elimination (de-loading) of the indenter 21. The indentation (load) curve as illustrated in FIG. 2B reflects the elasto-plastic deformation behavior of a material (non-magnetic metal plate as the sample 23) and the de-loading curve is obtained based on elastic recovery behavior. Further, the area surrounded by the loading curve and de-loading curve in FIG. 2B (hatched area with solid line) corresponds to the energy Ep consumed for the plastic deformation. Further, the area which is surrounded by the vertical line drawn from the maximum loading point in the loading curve to the horizontal axis (indentation depth h), the de-loading curve, and the horizontal axis (hatched area with broken line) corresponds to the energy Ee absorbed by the elastic deformation. Based on the above, a value of Ep/Ee×100(%) is obtained as elasto-plasticity ratio of an energy accompanied with the plastic deformation of particles. The Cu particles and Al particles, which are used as non-magnetic metal particles which have 50% or less of elasto-plasticity ratio of energy accompanied with plastic deformation of particles, all have the elasto-plasticity ratio of 50% or less, for example. Specifically, the Cu particles have the elasto-plasticity ratio of 22% and the Al particles have the elasto-plasticity ratio of 38%.

As for the carrier gas used for a cold spray method, low temperature (room temperature) He gas, which has been generated from a high pressure He bombe or a high pressure nitrogen bombe as the high pressure carrier gas generating unit 11, was used (more specifically, see Table 1). The low temperature carrier gas generated in the high pressure carrier gas generating unit 11 was heated by the heater for heating carrier gas 13. The temperature (gas temperature) of the heated primary carrier gas after heating by the heater for heating carrier gas 13 was maintained at constant temperature of 1000° C. As for the heater for heating carrier gas 13, kanthal wire as a heating resistor was used. Further, as the raw material powder supplying unit 15, a rotary stirrer for ensuring powder fluidity was installed inside a small-sized stainless hopper, and the following process was used: the raw material powder deposited on a mesh, which is installed on bottom part of the hopper, is filtered through the mesh while it is stirred by the stirrer. Via the raw material powder supplying unit 15, the raw material addition gas obtained by mixing the raw material powder with the same kind of gas as the carrier gas was added to the nozzle gun. Further, the addition amount of the raw material powder was in the range of 8.5/min (see, Table 1 below).

Temperature and pressure of the carrier gas were measured by the temperature sensor 18b and the pressure sensor 18a in the carrier gas accelerating unit (nozzle gun) 17, after the primary carrier gas and the raw material addition gas are mixed with each other.

The carrier gas accelerating unit 17 (nozzle gun) is equipped with a nozzle for spraying the carrier gas containing the raw material powder. By scanning the nozzle against the Cu substrate, the film was grown to obtain a thick film (molded magnet). By scanning several times the gas nozzle of the carrier gas accelerating unit 17 (nozzle gun) in the length direction of the Cu substrate, film thickening was achieved. With a staggering of 0.5 mm in width direction per scanning in length direction, a magnet film (molded magnet) with width of 10 mm was produced. Pass number was overlaid until the thickness reaches the further thickness of 0.3 mm to 1.5 mm to the original thickness of the substrate B.

In Example 1, a molded magnet was obtained by solidification molding with gas pressure of 0.8 MPa, carrier gas temperature of 270° C., and scanning speed of 50 mm/s.

The obtained molded magnet was first confirmed in terms of presence or absence of peeling appearance. Next, after polishing the surface, the obtained molded magnet was cut to have a sample of 5 mm size (both in length and width) and the magneticity measurement was performed for each Cu substrate by using a vibrating sample magnetometer (VSM). Correction of demagnetizing field was performed by calculating a thickness (obtaining the shape) after excluding the substrate thickness from the obtained film thickness. Values of the coercive force and residual magnetic flux density after solidification molding were evaluated by defining the value of the raw material powder as 100%.

Meanwhile, 0.03 g of the raw material powder was weighed, solidified with an epoxy resin to produce an isotropic bond magnet, and then evaluated using a VSM. With regard to the coercive force, the measured value was used without performing demagnetizing field correction.

Theoretical density indicates the density that is obtained from a case in which the main phase of a magnet (magnet powder; rare-earth magnet phase) in raw material powder used is assumed to have lattice constant obtained by X ray analysis and it corresponds to 100% volume of a molded magnet. Further, a density of 80% or higher of the theoretical density of a molded magnet is to define the volume ratio of the compound Sm₂Fe₁₄Nₓ (X=2 to 3) in a molded product.

Specifically, specific gravity of thus-obtained molded magnet was obtained first. Further, the molded magnet was shaven and concentration of the compound Sm₂Fe₁₄Nₓ (X=2 to 3) present inside was analyzed in terms of composition by ICP (inductively coupled plasma). Assuming that the compound Sm₂Fe₁₄Nₓ (X=2 to 3) is the same as the raw material, weight of Sm₂Fe₁₄Nₓ (X=2 to 3) in the molded magnet was calculated.

First, the density was measured by Archimedes's method after removing the Cu substrate by fraise processing. Separately, concentration of the added metal was quantified by wet analysis (it was also the same with Mn, Cu, and Al that are used in other Examples, in addition to Zn of Example 1). By calculating the density corresponding to the weight obtained by subtracting the weight corresponding to the concentration of Zn, Mn, Cu, and Al, the relative value compared to the theoretical density was obtained.

The lattice constant of Sm₂Fe₁₄Nₓ (x=2 to 3) compound used was measured by X ray analysis and the theoretical density was calculated to be 7.67 g/cm³. By using that value, the ratio (%) compared to the theoretical density was calculated. The obtained results are summarized in Table 1.

### Examples 2 to 4

In Examples 2 to 4, the same operations as Example 1 were performed except that the blending amount (volume ratio) of Zn particles to be blended is changed to 10%, 5%, or 3% in order from 15% of Example 1. The obtained results are summarized in Table 1.

### Example 5

In Example 5, the same operations as Example 2 were performed except that the gas pressure, gas temperature, and scanning speed for cold spray method are modified. In Example 2, the molded magnet was obtained by solidification molding with gas pressure of 0.8 MPa, carrier gas temperature of 270° C., and scanning speed of 50 mm/s. In Example 5, the molded magnet was obtained by solidification molding with gas pressure of 0.6 MPa, carrier gas temperature of 200° C., and scanning speed of 100 mm/s. The obtained results are summarized in Table 1.

### Examples 6 to 8

In Examples 6 to 8, the operation for blending, simultaneously with Zn particles, Cu particles, and Al particles having elasto-plasticity ratio of 50% or less was performed in addition to Example 2. Specifically, the same operations as Example 2 were performed except that the blending amount (volume ratio) of Cu particles is 3% in Example 6, the blending amount (volume ratio) of Cu particles is 5% in Example 7, and the blending amount (volume ratio) of Cu particles is 3% and the blending amount (volume ratio) of Al particles is 2% in Example 8. The obtained results are summarized in Table 1.

### Example 9

In Example 9, the operation for using Mn particles as metal particles for addition instead of Zn particles and also adding Cu particles was performed in addition to Example 3. Specifically, the same operations as Example 1 were performed except that the blending amount (volume ratio) of Mn particles is 5% and the blending amount (volume ratio) of Cu particles having elasto-plasticity ratio of 50% or less is 3% in Example 9 while the blending amount (volume ratio) of Zn particles is 5% in Example 1. The obtained results are summarized in Table 1.

### Example 10

In Example 10, the operation of modifying the gas pressure and gas temperature in the cold spray method and blending Zn particles, Mn particles, and Cu particles as metal particles for addition was performed in Example 1. Specifically, gas pressure was 0.8 MPa, carrier gas temperature was 270° C., and the blending amount (volume ratio) of Zn particles was 15% in Example 1. Compared to this, the same operations as Example 1 were performed except that gas pressure was 0.6 MPa, carrier gas temperature was 200° C., and the blending amount (volume ratio) of Zn particles was 5%, the blending amount (volume ratio) of Mn particles was 2%, and the blending amount (volume ratio) of Cu particles having elasto-plasticity ratio of 50% or less is 3% in Example 10. The obtained results are summarized in Table 1.

### Example 11

In Example 11, the same operations as Example 2 were performed except that the gas type for cold spray method is changed to N₂, and gas pressure and gas temperature are modified. Specifically, the same operations as Example 2 were performed except that gas type was N₂, gas pressure was 2.8 MPa, and carrier gas temperature was 300° C. in Example 11 while gas type was He, gas pressure was 0.8 MPa, and carrier gas temperature was 270° C. in Example 2. The obtained results are summarized in Table 1.

### Example 12

In Example 12, the operation of blending Cu particles was performed in addition to Example 11. Specifically, the same operations as Example 11 were performed except that the blending amount (volume ratio) of Cu particles was 3% in Example 12 while non-magnetic metal particles having elasto-plasticity ratio of 50% or less are not blended in Example 11. The obtained results are summarized in Table 1.

### Examples 13 and 14

In Examples 13 and 14, the blending amount of Zn particles of Example 12 was changed. Specifically, the same operations as Example 12 were performed except that the blending amount (volume ratio) of Zn particles was 5% in Example 13 and the blending amount (volume ratio) of Zn particles was 3% in Example 14 while the blending amount (volume ratio) of Zn particles was 10% in Example 12. The obtained results are summarized in Table 1.

### Example 15

In Example 15, the gas temperature for cold spray method of Example 12 was changed and also Zn particles as metal particles for addition were changed to Mn particles. Specifically, the same operations as Example 12 were performed except that carrier gas temperature was 350° C. and the blending amount (volume ratio) of Mn particles was 10% in Example 15 while carrier gas temperature was 300° C. and the blending amount (volume ratio) of Zn particles was 10% in Example 12. The obtained results are summarized in Table 1.

### Example 16

In Example 16, Zn particles of Example 13 were change to Mn particles. Specifically, the same operations as Example 12 were performed except that the blending amount (volume ratio) of Mn particles was 5% in Example 16 while the blending amount (volume ratio) of Zn particles was 5% in Example 13. The obtained results are summarized in Table 1.

### Example 17

In Example 17, the scanning speed was modified from that of Example 15 and the operation of blending Zn particles, Mn particles, and Al particles as metal particles for addition was performed. Specifically, in Example 15, the scanning speed was 50 mm/s and the blending amount (volume ratio) of Mn particles was 10%. In Example 17, the same operations as Example 15 were performed except that the scanning speed was 100 mm/s, the blending amount (volume ratio) of Zn particles was 3%, the blending amount (volume ratio) of Mn particles was 10%, and the blending amount (volume ratio) of Al particles with elasto-plasticity ratio of 50% or less was 1%. The obtained results are summarized in Table 1.

### Comparative Example 1

In Comparative Example 1, the metal particles for addition were changed from those of Example 1 and the operation of blending only Cu particles with elasto-plasticity ratio of 50% or less was performed. Specifically, the same operations as Example 1 were performed except that the blending amount (volume ratio) of Cu particles with elasto-plasticity ratio of 50% or less was 20% in Comparative Example 1 while the blending amount (volume ratio) of Zn particles was 15% in Example 1. The obtained results are summarized in Table 1. As a result, it was possible to confirm that, even when the blending amount of Cu particles is increased to 20% in Comparative Example 1 while not containing Zn/Mn particles, a significant decrease in the residual magnetic flux density cannot be suppressed.

### Comparative Example 2

In Comparative Example 2, the blending amount of Zn particles in Example 1 was changed. Specifically, the same operations as Example 1 were performed except that the blending amount (volume ratio) of Zn particles was 20% in Comparative Example 2 while the blending amount (volume ratio) of Zn particles was 15% in Example 1. The obtained results are summarized in Table 1. From the results of Table 1, it was possible to confirm that, even when the blending amount (volume ratio) of the metal particles for addition was increased from 15% to 20%, the effect of improving the coercive force is small and a significant decrease in the residual magnetic flux density cannot be suppressed.

### Comparative Example 3

In Comparative Example 3, the gas type for cold spray method of Example 2 was changed. Specifically, the same operations as Example 2 were performed except that the carrier gas was air in Comparative Example 3 while the carrier gas was He in Example 2. The obtained results are summarized in Table 1. From the results of Table 1, it was possible to confirm that, when the carrier gas is not inert gas but contains active gas like air, there is a significant decrease in the coercive force and residual magnetic flux density.

### Comparative Example 4

In Comparative Example 4, the gas pressure and gas temperature for cold spray method were changed from those of Example 11, the metal particles for addition were changed, and the operation of blending only the Cu particles was performed. Specifically, in Example 11, the gas pressure was 2.8 MPa, carrier gas temperature was 300° C., and the blending amount (volume ratio) of Zn particles with elasto-plasticity ratio of 50% or less was 10%. In Comparative Example 4, the same operations as Example 11 were performed except that the gas pressure was 1.28 MPa, carrier gas temperature was 780° C., and the blending amount (volume ratio) of Cu particles with elasto-plasticity ratio of 50% or less was 1%. The obtained results are summarized in Table 1. From the results of Table 1, it was possible to confirm that, because the carrier gas temperature was significantly higher than the decomposition temperature (450° C.) of a nitrogen compound (magnet particles), there is a significant decrease in the coercive force and residual magnetic flux density.

### Comparative Example 5

In Comparative Example 5, the metal particles for addition were changed from those of Comparative Example 1. Specifically, the same operations as Comparative Example 1 were performed except that the non-magnetic metal particles having elasto-plasticity ratio of 50% or less are not used in Comparative Example 5 while the blending amount (volume ratio) of the Cu particles with elasto-plasticity ratio of 50% or less was 20% in Comparative Example 1. The obtained results are summarized in Table 1. From the results of Table 1, it was possible to confirm that, like Comparative Example 1 (and also Comparative Example 4), as the non-magnetic metal particles with elasto-plasticity ratio of 50% or less are not contained in Comparative Example 5, the tight adhesion was poor so that a peeling appearance has occurred.

Hereinabove, the present invention is described in view of Examples, detailed in the table below. However, the present invention is not limited to Examples given above.

TABLE 1

| | | | | | | | | Relative | | | |
|---|---|---|---|---|---|---|---|---|---|---|---|
| | | | | | | | | value | | | |
| | | | | | | | Supply | compared | | | |
| | | | | | | | amount | to | Coercive | Residual | Appearance |
| | | Gas | Gas | Scanning | Zn•Mn | Metal particles | of | theoretical | force • H | magnetic | Presence or |
| | Gas | pressure | temperature | speed | blending | blending | powder | density | Relative | flux | absence of |
| | type | MPa | ° C. | mm/s | amount | amount | g/min | % | value | density | peeling |
| Example 1 | He | 0.8 | 270 | 50 | Zn • 15% | — | 8.5 | 82.5 | 1.38 | 0.81 | No |
| Example 2 | He | 0.8 | 270 | 50 | Zn • 10% | — | 8.5 | 87.3 | 1.23 | 0.86 | No |
| Example 3 | He | 0.8 | 270 | 50 | Zn • 5% | — | 8.5 | 92.2 | 1.15 | 0.90 | No |
| Example 4 | He | 0.8 | 270 | 50 | Zn • 3% | — | 8.5 | 94.1 | 1.08 | 0.92 | No |
| Example 5 | He | 0.6 | 200 | 100 | Zn • 10% | — | 8.5 | 87.3 | 1.42 | 0.86 | No |
| Example 6 | He | 0.8 | 270 | 50 | Zn • 10% | Cu • 3% | 8.5 | 84.4 | 1.31 | 0.83 | No |
| Example 7 | He | 0.8 | 270 | 50 | Zn • 10% | Cu • 5% | 8.5 | 82.5 | 1.35 | 0.81 | No |
| Example 8 | He | 0.8 | 270 | 50 | Zn • 10% | Cu • 3%, Al • 2% | 8.5 | 82.5 | 1.32 | 0.81 | No |
| Example 9 | He | 0.8 | 270 | 50 | Mn • 5% | Cu • 3% | 8.5 | 89.2 | 1.05 | 0.87 | No |
| Example 10 | He | 0.6 | 200 | 50 | Zn • 5%, | Cu • 3% | 8.5 | 89.2 | 1.18 | 0.86 | No |
| | | | | | Mn • 2% | | | | | | |
| Example 11 | N2 | 2.8 | 300 | 50 | Zn • 10% | — | 8.5 | 87.3 | 1.19 | 0.86 | No |
| Example 12 | N2 | 2.8 | 300 | 50 | Zn • 10% | Cu • 3% | 8.5 | 84.4 | 1.27 | 0.83 | No |
| Example 13 | N2 | 2.8 | 300 | 50 | Zn • 5% | Cu • 3% | 8.5 | 89.2 | 1.14 | 0.87 | No |
| Example 14 | N2 | 2.8 | 300 | 50 | Zn • 3% | Cu • 3% | 8.5 | 91.2 | 1.06 | 0.89 | No |
| Example 15 | N2 | 2.8 | 350 | 50 | Mn • 10% | Cu • 3% | 8.5 | 84.4 | 1.13 | 0.83 | No |
| Example 16 | N2 | 2.8 | 350 | 50 | Mn • 5% | Cu • 3% | 8.5 | 89.2 | 1.10 | 0.87 | No |
| Example 17 | N2 | 2.8 | 350 | 100 | Zn • 3%, | Al • 1% | 8.5 | 83.4 | 1.21 | 0.82 | No |
| | | | | | Mn • 10% | | | | | | |
| Comparative | He | 0.8 | 270 | 50 | — | Cu • 20% | 8.5 | 77.6 | 0.98 | 0.74 | No |
| Example 1 | | | | | | | | | | | |
| Comparative | He | 0.8 | 270 | 50 | Zn • 20% | — | 8.5 | 77.6 | 1.37 | 0.74 | No |
| Example 2 | | | | | | | | | | | |
| Comparative | Air | 0.8 | 270 | 50 | Zn • 10% | — | 8.5 | 87.3 | 0.31 | 0.34 | No |
| Example 3 | | | | | | | | | | | |
| Comparative | N2 | 1.2 | 780 | 50 | — | Cu • 1% | 8.5 | 96.0 | 0.21 | 0.27 | No |
| Example 4 | | | | | | | | | | | |
| Comparative | He | 0.8 | 270 | 50 | — | — | 8.5 | 96.3 | 0.93 | 0.89 | Yes |
| Example 5 | | | | | | | | | | | |

1. A molded rare-earth magnet comprising:
a rare-earth magnet phase that contains as a main component a nitride which contains Sm and Fe, wherein the molded rare-earth magnet has a density of 80% or higher of the theoretical density of a molded magnet constituted of the rare-earth magnet phase, and has a structure in which particles of Zn and/or Mn and non-magnetic metal particles which have 50% or less of elasto-plasticity ratio of energy accompanied with plastic deformation of particles are dispersed in the molded magnet, and
the molded magnet is obtained by using a process of forming a powder film by which the film is formed by depositing particles.

2. The molded rare-earth magnet according to claim 1, wherein a content of Zn and/or Mn is more than 0% but equal to or less than 15% in terms of volume ratio.

3. The molded rare-earth magnet according to claim 1, wherein coercive force of the molded magnet (relative value of a value after solidification molding when a value of raw material powder is 100%) is 1.00 or more or residual magnetic flux density (relative value of the value after solidification molding when the value of the raw material powder is 100%) is 0.75 or more.

4. (canceled)

5. The molded rare-earth magnet according to claim 1, wherein a thickness of the molded magnet is 200 to 3000 μm.

6. (canceled)

7. The molded rare-earth magnet according to claim 1, wherein the particles used for the process of forming a powder film by which the film is formed by depositing the particles include rare-earth magnet powder which contains as a main component a nitrogen compound containing Sm and Fe and Zn and/or Mn particles, and non-magnetic metal particles which have 50% or less of elasto-plasticity ratio of energy accompanied with plastic deformation of particles.

8. (canceled)

9. A method for producing a molded magnet comprising:
a spraying step in which a raw material powder containing nitride is mixed with carrier gas and the raw material powder is sprayed with high speed carrier gas in an accelerated state; and
a solidification molding step in which the sprayed raw material powder is deposited on a substrate for solidification molding,
wherein the raw material powder contains nitride-based rare-earth magnet powder and Zn and/or Mn particles, and non-magnetic metal particles which have 50% or less of elasto-plasticity ratio of energy accompanied with plastic deformation of particles,
temperature of the high speed carrier gas at the spraying step is lower than decomposition temperature of the nitride, and
the solidification molding step is performed under atmospheric pressure.

10. The method for producing a molded magnet according to claim 9, further comprising a step of heating the carrier gas before mixing the carrier gas with the raw material powder.

11. The method for producing a molded magnet according to claim 9, wherein inert gas is used as the carrier gas.

12. The method for producing a molded magnet according to claim 9, wherein the raw material powder contains magnet powder for constituting a rare-earth magnet phase which contains Sm—Fe—N as a main component and Zn/Mn particles, and non-magnetic metal particles which have 50% or less of elasto-plasticity ratio of energy accompanied with plastic deformation of particles.

13. (canceled)

14. A magnet motor obtained by using the molded magnet according to claim 1.
